(19) United States
(12) Patent Application Publication
(10) Pub. No.: US 2018/0189549 A1
(43) Pub. Date: Jul. 5, 2018

(54) METHOD FOR COMMUNICATION VIA VIRTUAL SPACE, PROGRAM FOR EXECUTING THE METHOD ON COMPUTER, AND INFORMATION PROCESSING APPARATUS FOR EXECUTING THE PROGRAM

(71) Applicant: COLOPL, Inc., Tokyo (JP)

(72) Inventor: Atsushi INOMATA, Kanagawa (JP)

(21) Appl. No.: 15/853,928

(22) Filed: Dec. 25, 2017

(30) Foreign Application Priority Data
Dec. 26, 2016 (JP) 2016-250994

(51) Int. Cl. G06K 9/00; G06T 19/00; G06T 13/40; G06F 3/01

(52) U.S. Cl. CPC G06K 9/00281; G06F 3/011; G06T 13/40; G06T 19/006

(57) ABSTRACT

[Object] To provide a technology for achieving smoother communication in a virtual space.

[Solving Means] Provided is a method including: defining a virtual space, the virtual space including: a first avatar object, which is associated with a first user, and includes a second mouth and a second tongue; and a second avatar object, which is associated with a second user; repeatedly receiving input of a face image containing a first mouth of the first user; detecting that the face image contains a lower lip forming the first mouth; detecting that at least a part of the detected lower lip is hidden; changing, when at least a part of the lower lip is hidden, a state of the avatar object to a state in which the second tongue of the avatar object is protruding from the second mouth of the avatar object; and displaying, in a field of view of the first user or the second user, the avatar object in a state in which the second tongue is protruding from the second mouth.

### TECHNICAL FIELD

This disclosure relates to a technology of controlling an avatar arranged in a virtual space, and more particularly, to a technology of controlling a facial expression of the avatar.

### BACKGROUND ART

There is known a technology of providing virtual reality with use of a head-mounted device (HMD). There is proposed a technology of arranging respective avatars of a plurality of users in a virtual space for communication among the plurality of users via those avatars.

As a technology of enhancing communication using avatars, there is known a technology of detecting a motion of a face of a user by a face-tracking technology (Patent Documents 1 to 4) and reflecting the detected motion of the face in an avatar. For example, in Patent Document 1, there is disclosed a technology of detecting a motion of a mouth of a user by pattern matching. In Patent Document 4, there is proposed a technology involving “extracting a region of interest, such as a tongue tip, a tongue middle, a tongue left edge, a tongue right edge, and a tongue base, by matching a tongue image having a hue corrected by a hue compensation unit 21 and a basic template image of each individual person stored in a tongue image database 15” (see paragraph [0019]).

### RELATED ART

### Patent Documents

[Patent Document 1] JP 2009-231879 A

[Patent Document 2] JP 2009-533786 A

[Patent Document 3] JP 2010-507854 A

[Patent Document 4] JP 2004-209245 A

### SUMMARY

### Means for Solving the Problem

According to one embodiment of this disclosure, there is provided a method including: defining a virtual space, the virtual space including: a first avatar object, which is associated with a first user, and includes a second mouth and a second tongue; and a second avatar object, which is associated with a second user; repeatedly receiving input of a face image containing a first mouth of the first user; detecting that the face image contains a lower lip forming the first mouth; detecting that at least a part of the detected lower lip is hidden; changing, when at least a part of the lower lip is hidden, a state of the avatar object to a state in which the second tongue of the avatar object is protruding from the second mouth of the avatar object; and displaying, in a field of view of the first user or the second user, the avatar object in a state in which the second tongue is protruding from the second mouth.

The above-mentioned and other objects, features, aspects, and advantages of the disclosure may be made clear from the following detailed description of this disclosure, which is to be understood in association with the attached drawings.

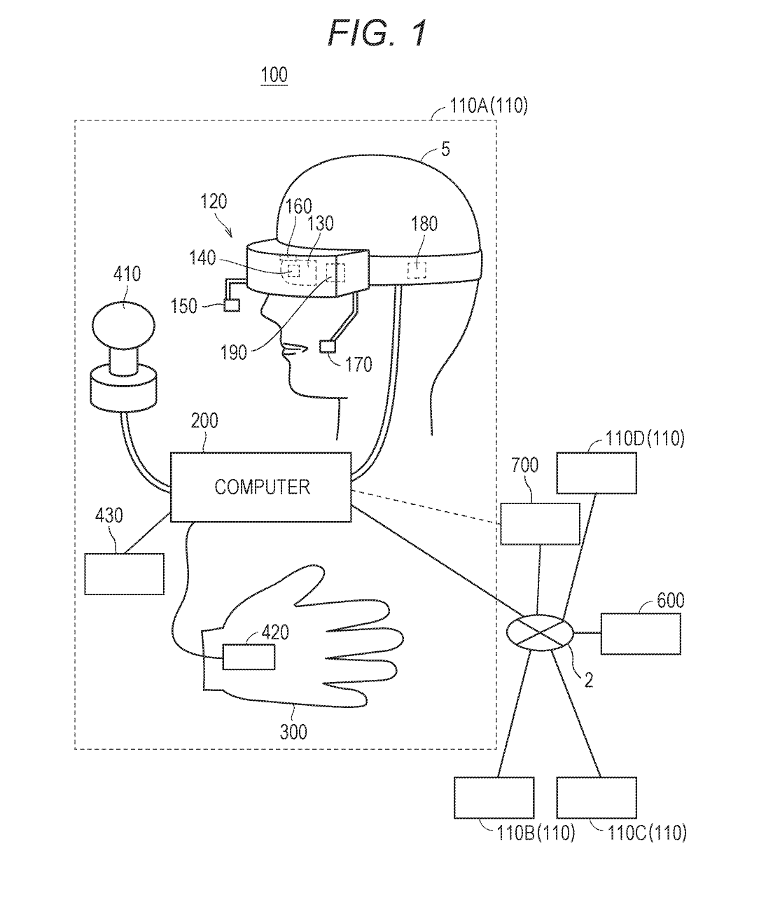

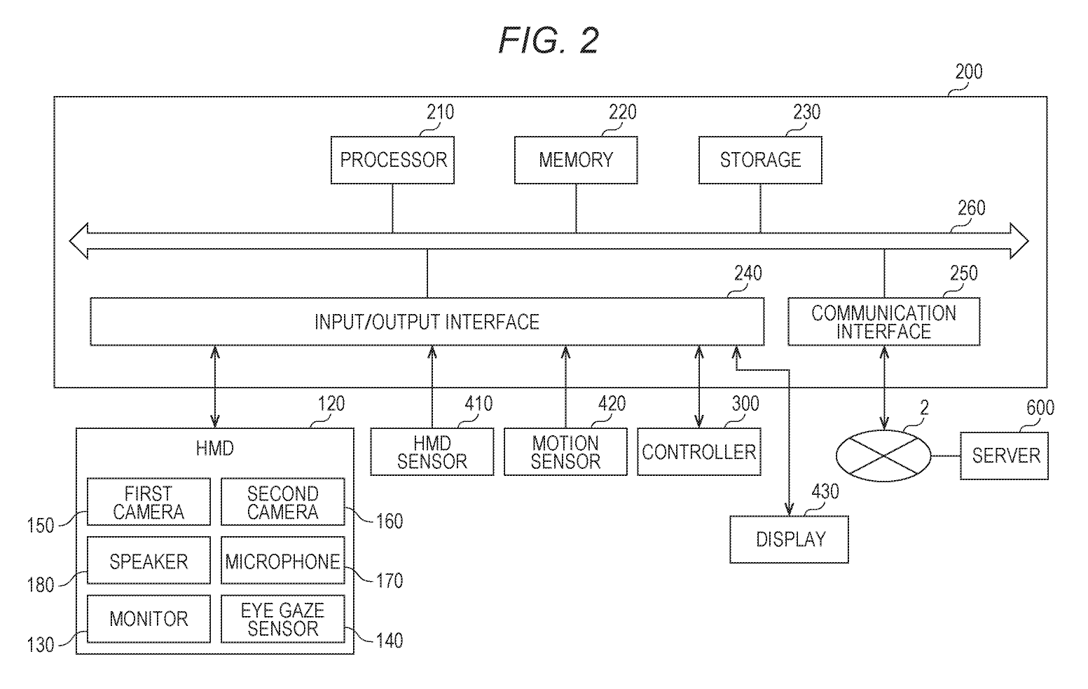

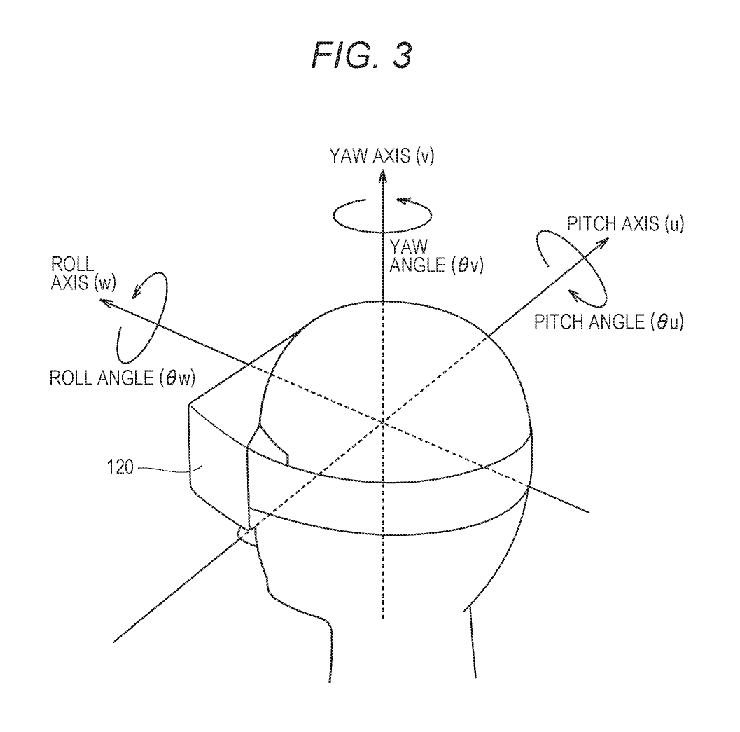

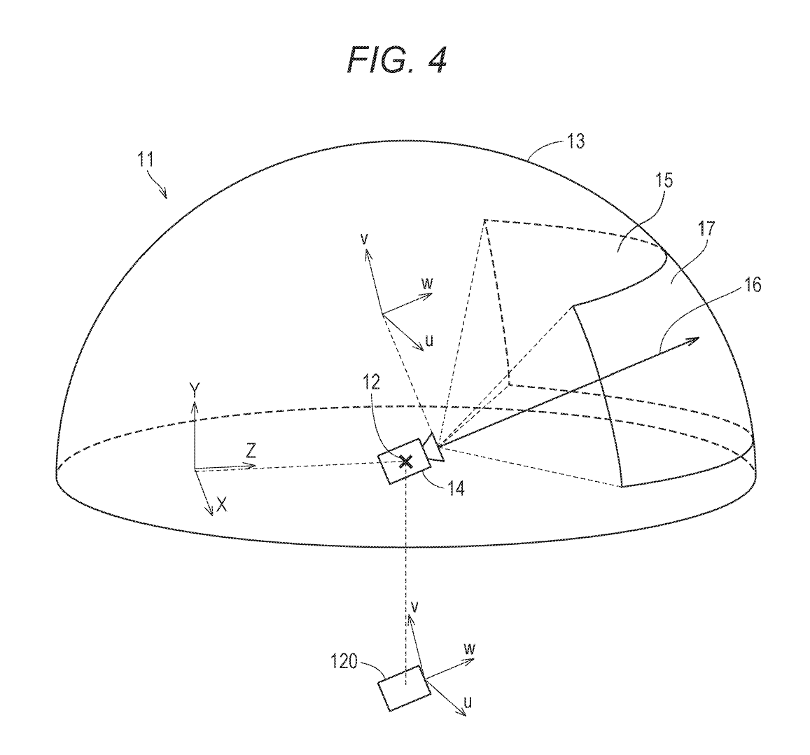

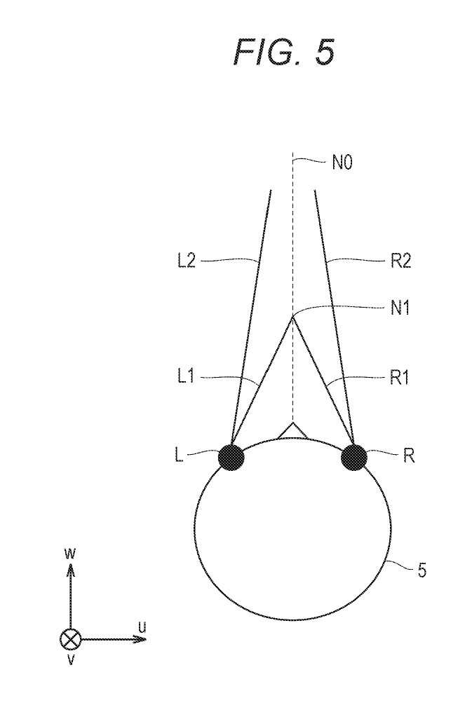

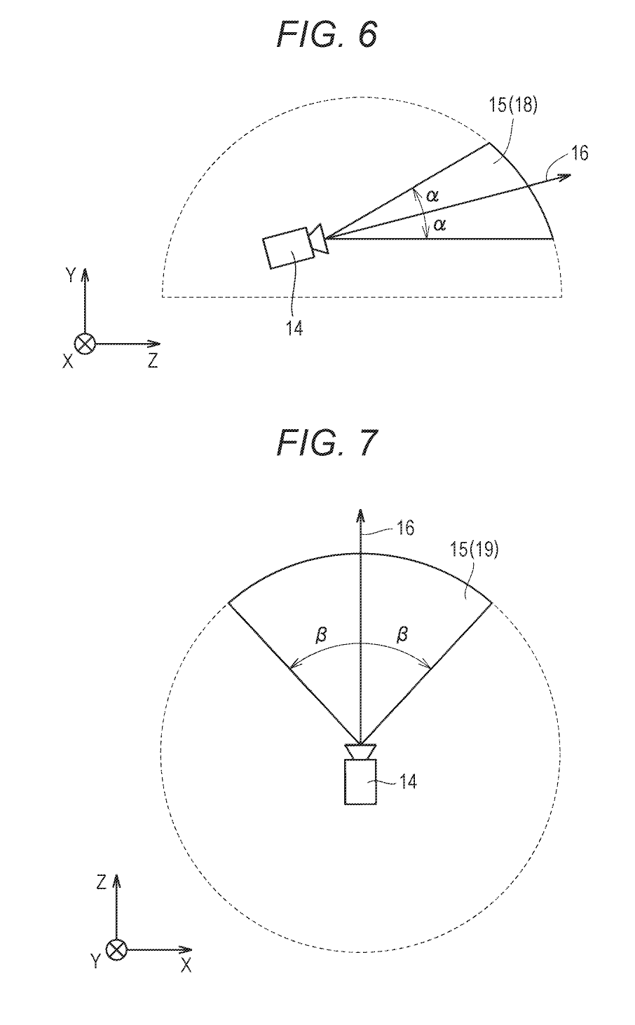

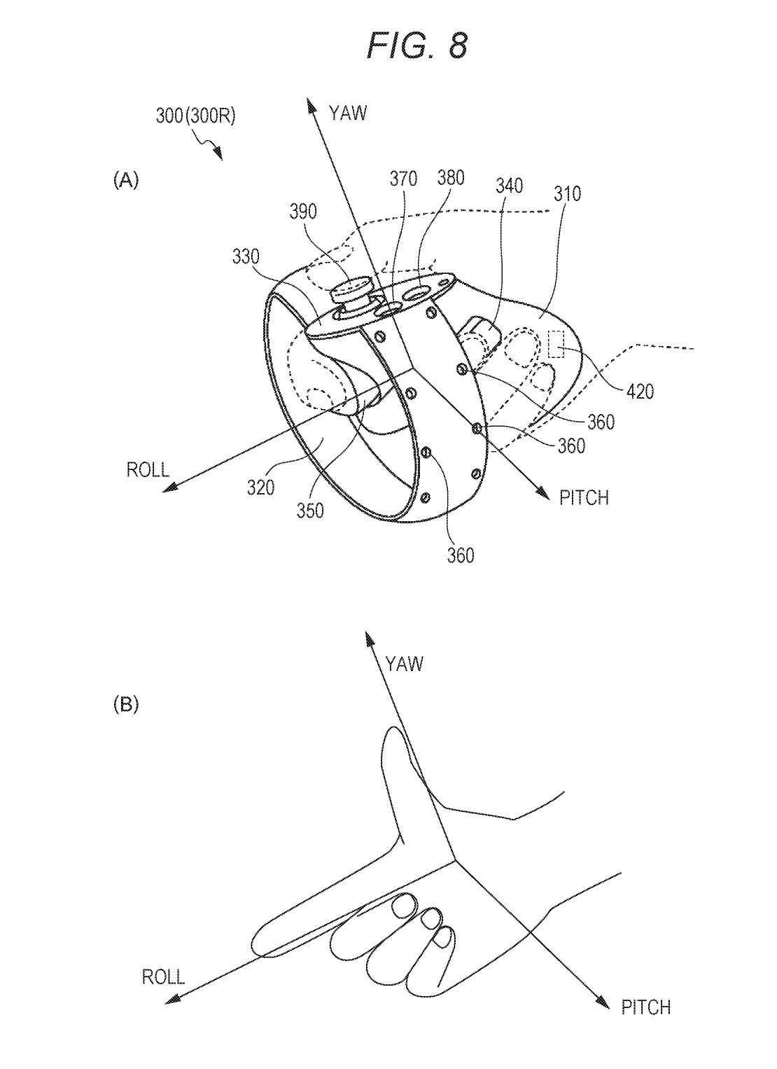

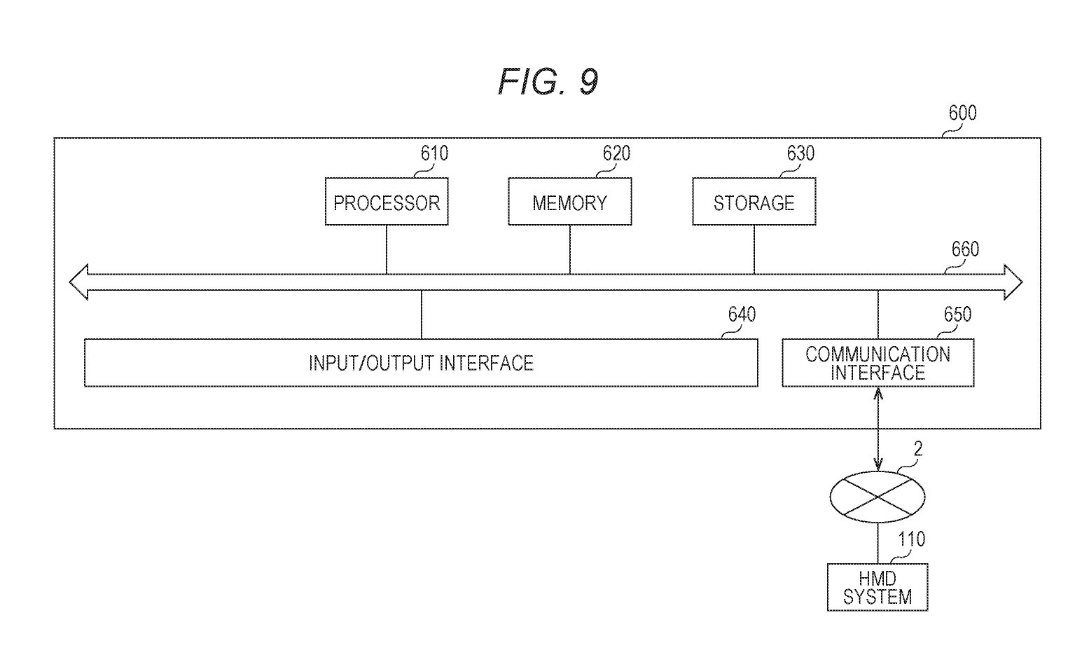

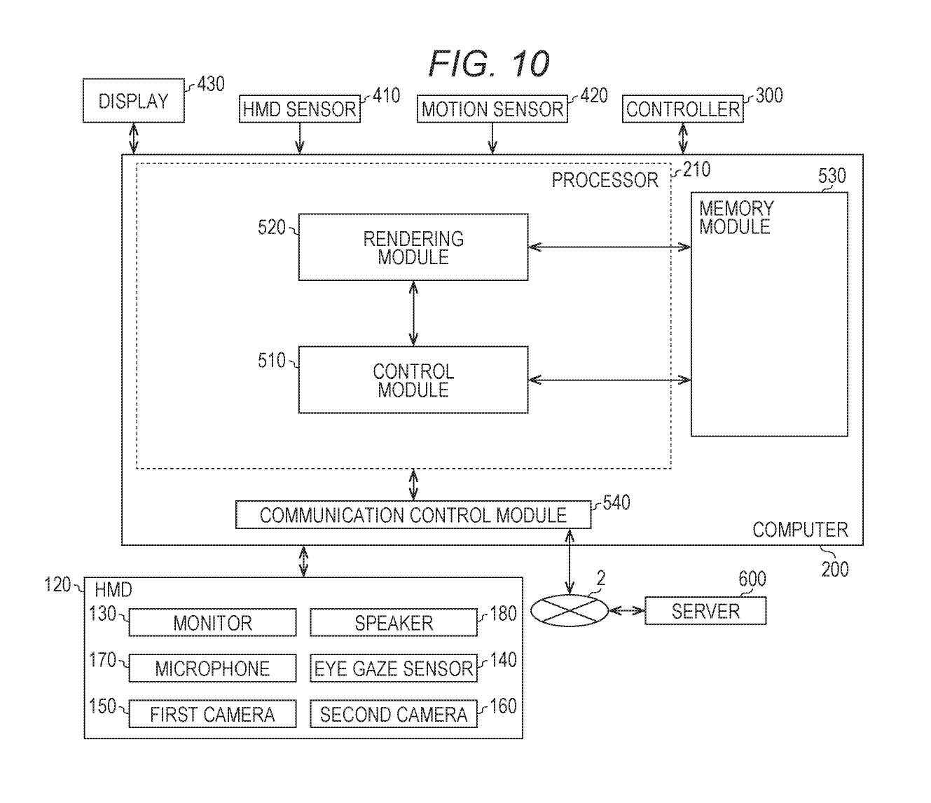

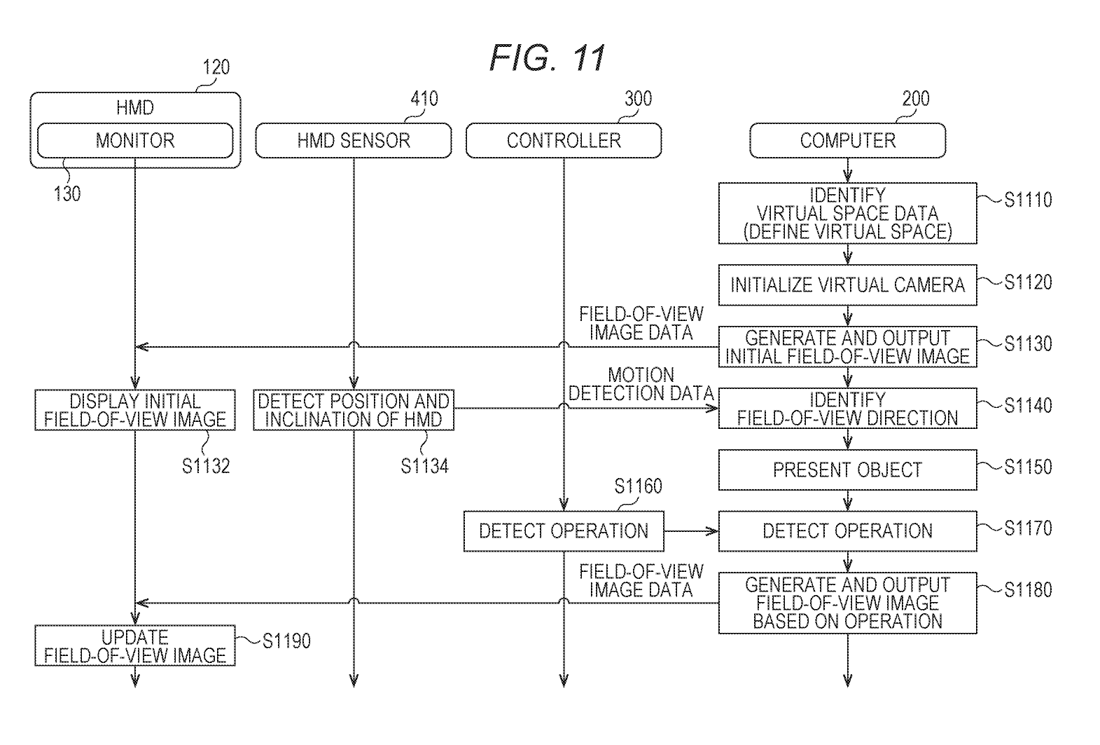

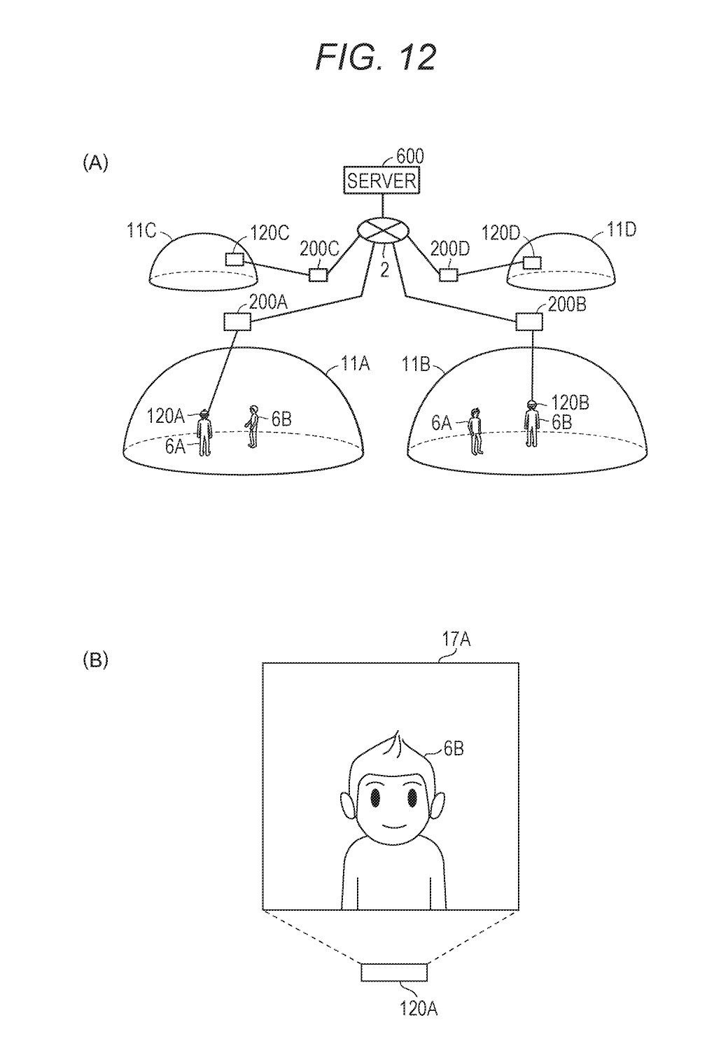

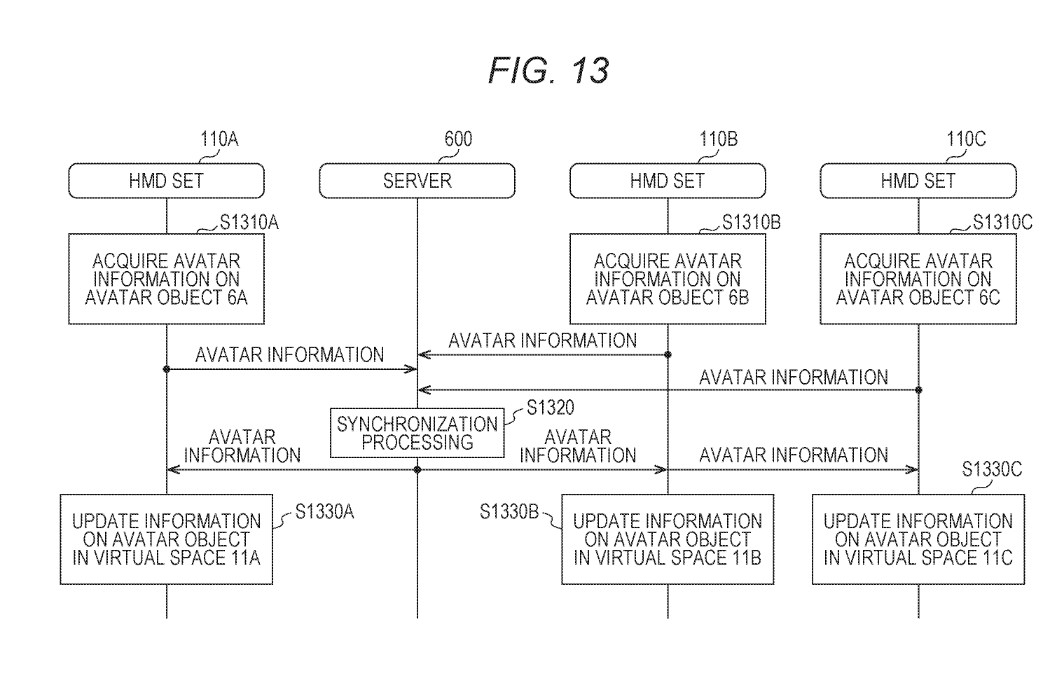

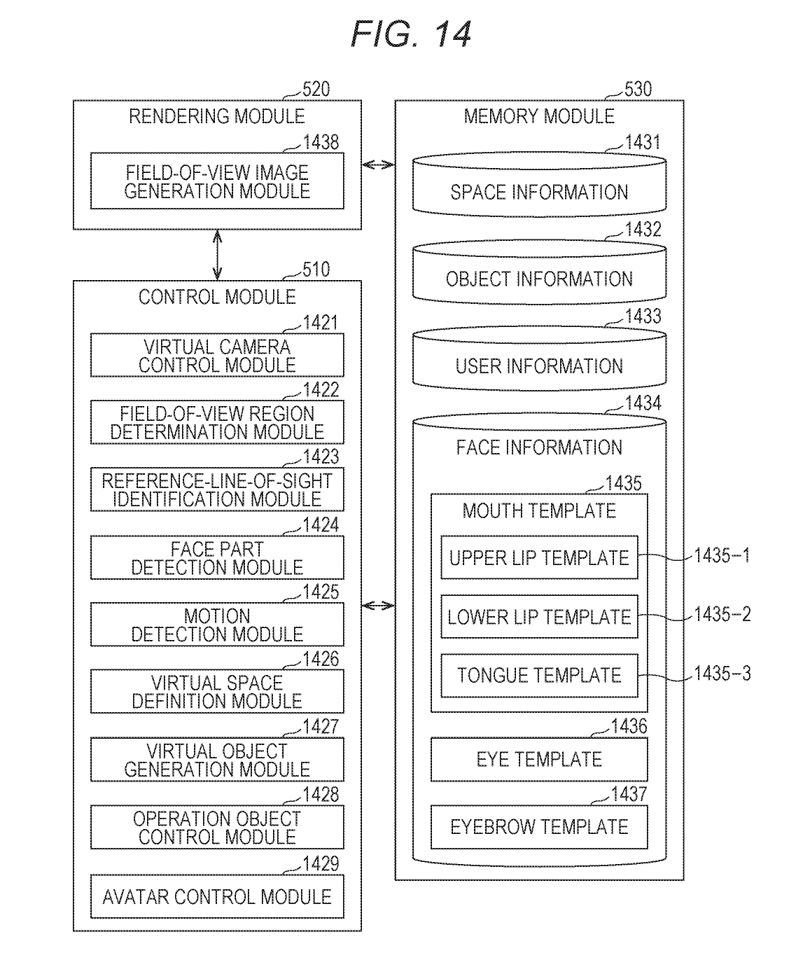

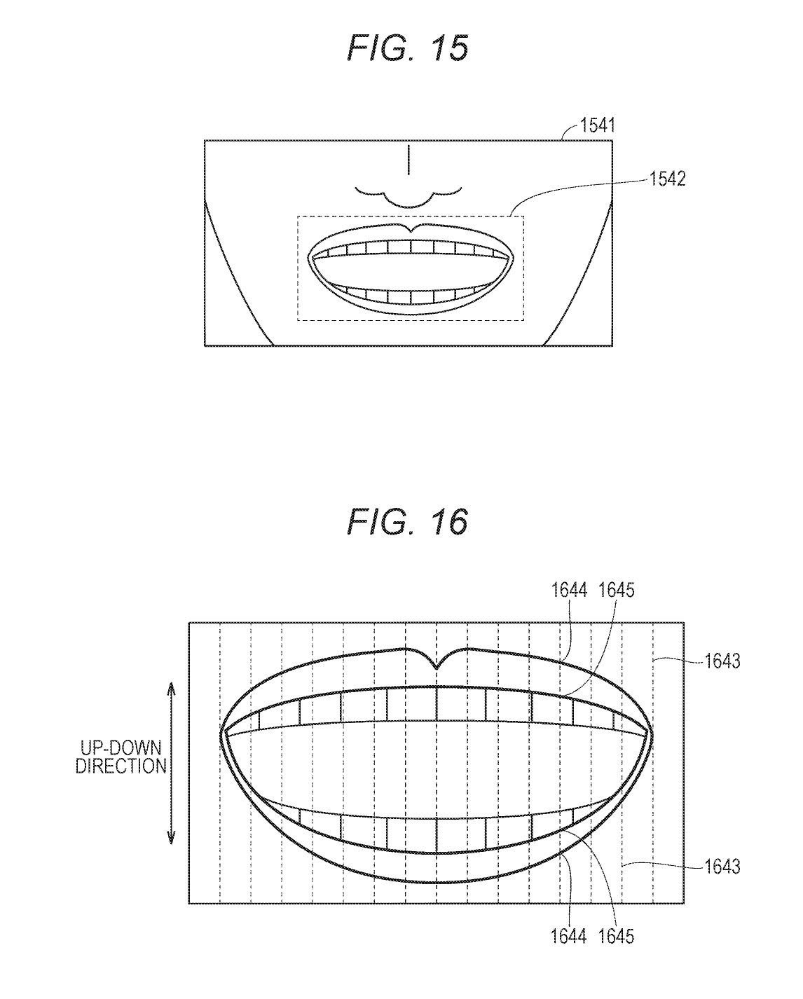

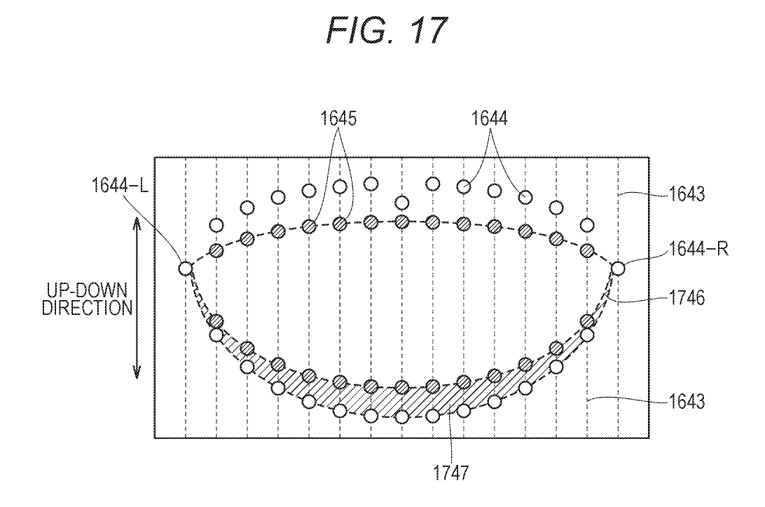

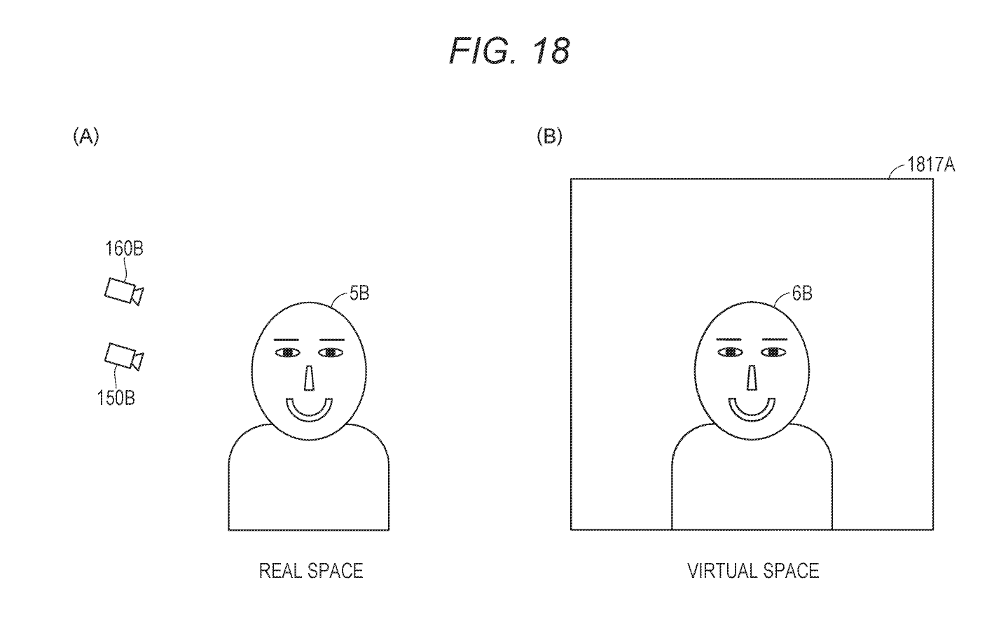

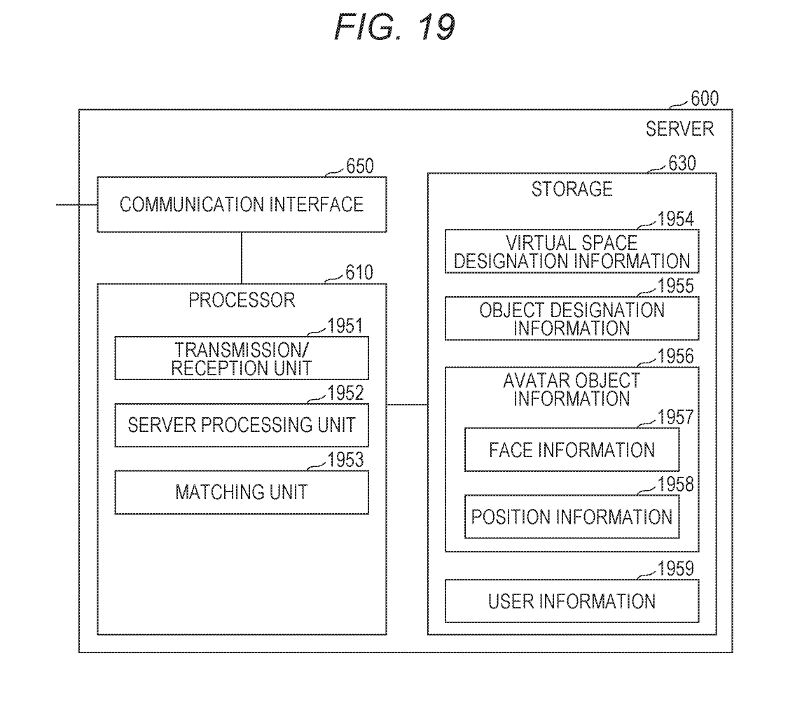

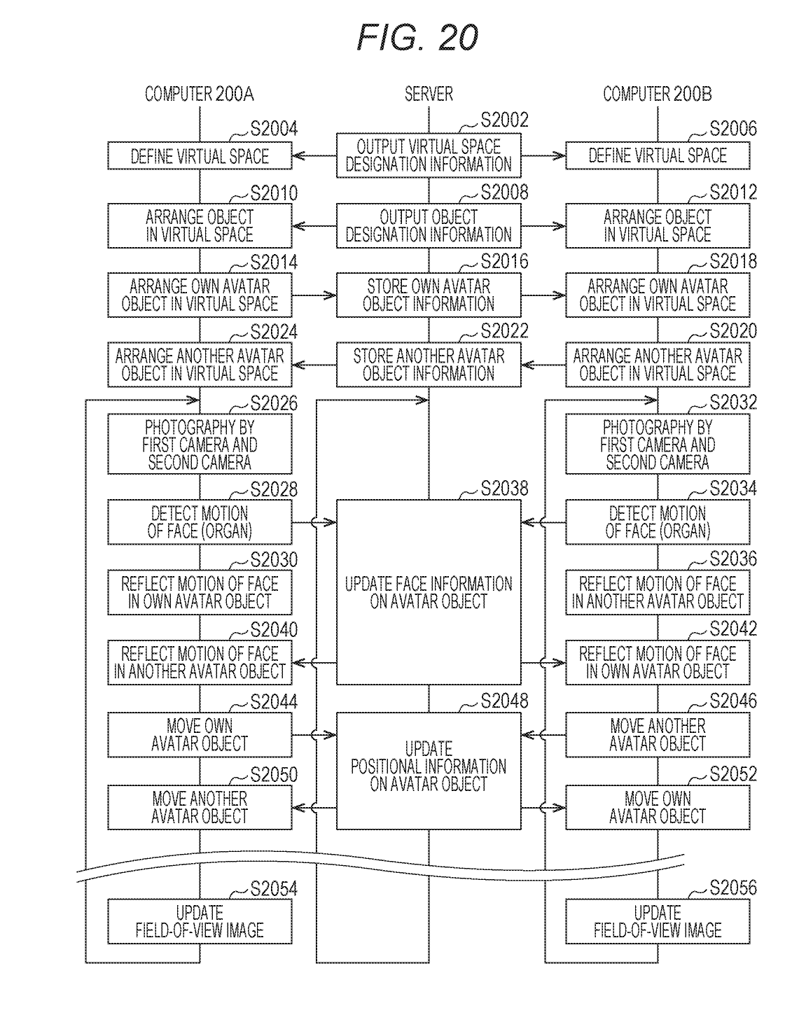

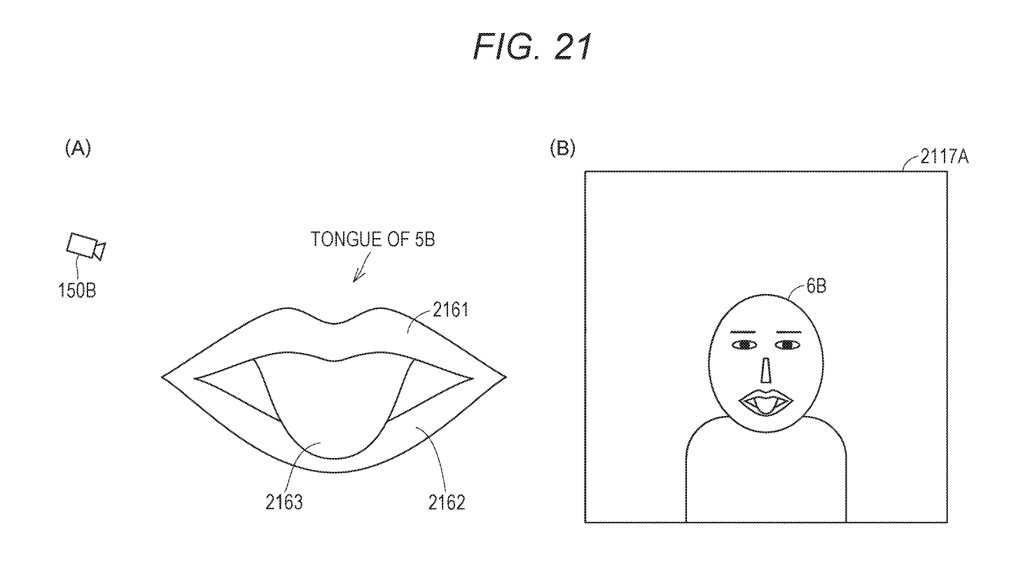

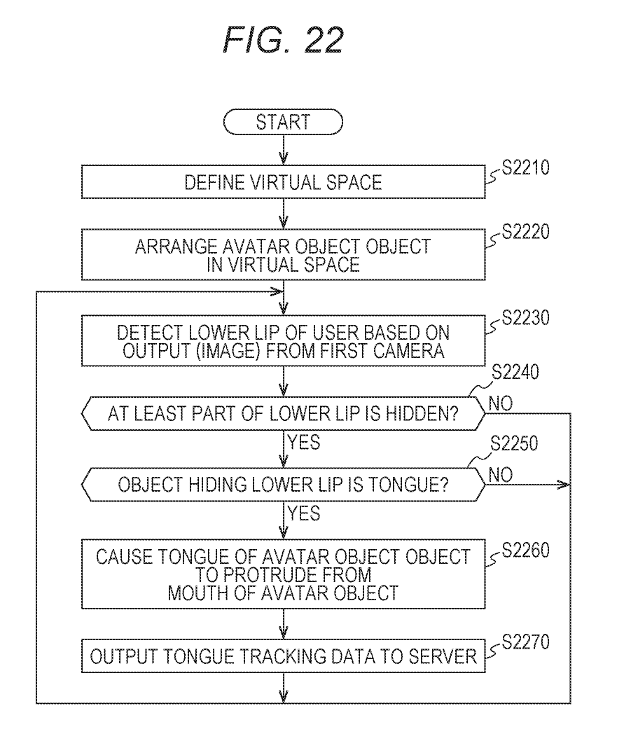

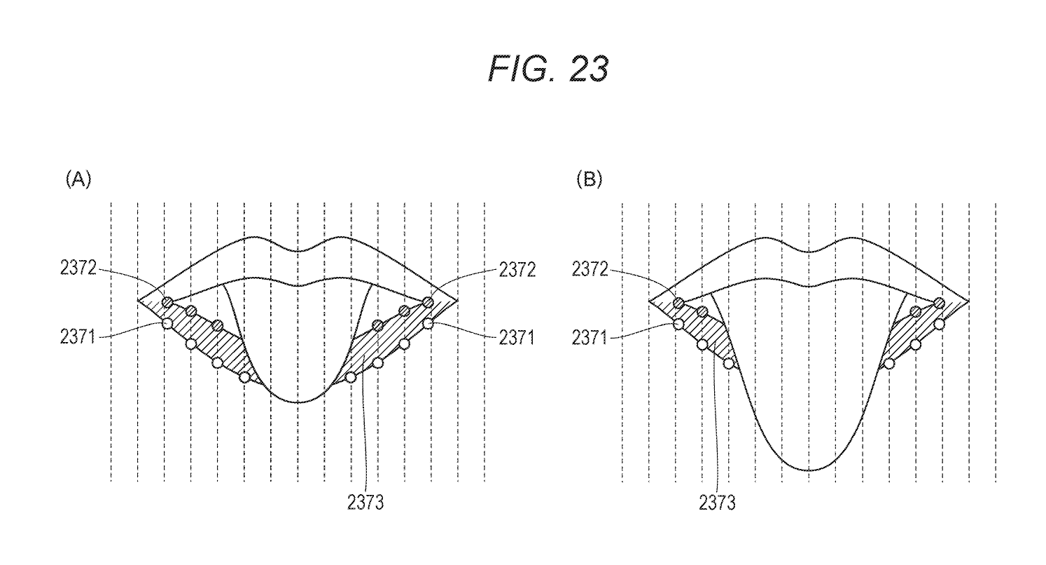

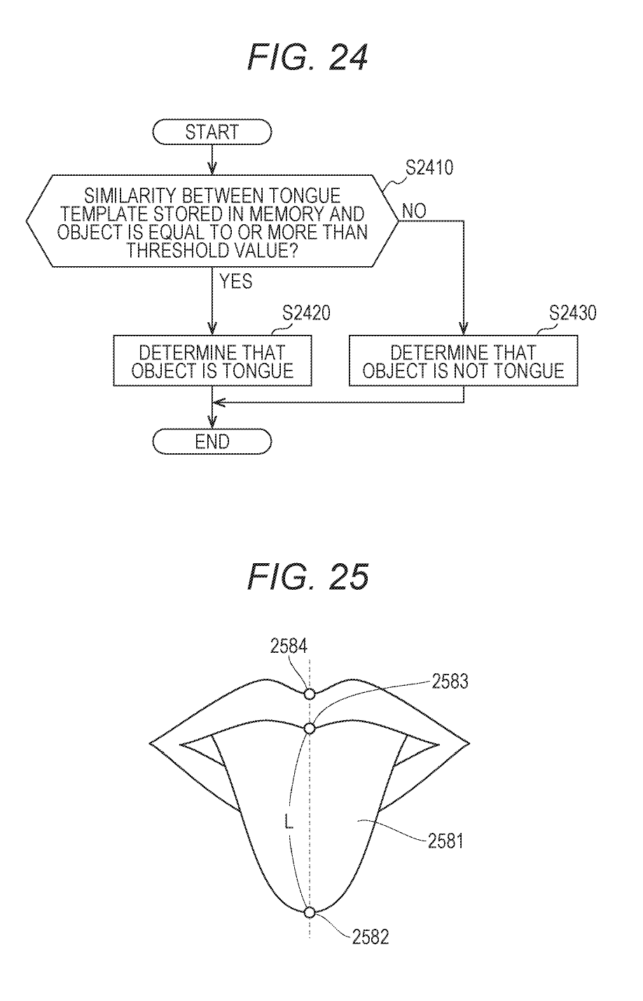

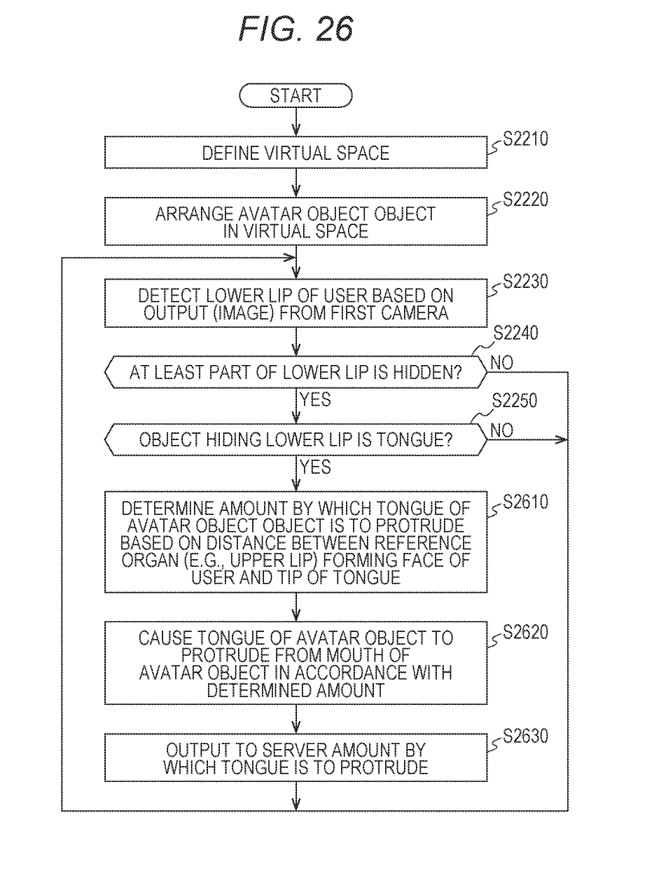

### BRIEF DESCRIPTION OF THE DRAWINGS

[FIG. 1] A diagram for illustrating an overview of a configuration of an HMD system in one embodiment of this disclosure.

[FIG. 2] A block diagram for illustrating an example of a hardware configuration of a computer in one embodiment of this disclosure.

[FIG. 3] A diagram for schematically illustrating a uvw visual-field coordinate system to be set for an HMD in one embodiment of this disclosure.

[FIG. 4] A diagram for schematically illustrating one mode of expressing a virtual space in one embodiment of this disclosure.

[FIG. 5] A diagram for illustrating, from above, a head of a user wearing the HMD in one embodiment of this disclosure.

[FIG. 6] A diagram for illustrating a YZ cross section obtained by viewing a field-of-view region from an X direction in the virtual space.

[FIG. 7] A diagram for illustrating an XZ cross section obtained by viewing the field-of-view region from a Y direction in the virtual space.

[FIGS. 8A] Diagrams for illustrating a schematic configuration of a controller in one embodiment of this disclosure.

[FIG. 8B] A diagram for illustrating an example of a yaw direction, a roll direction, and a pitch direction that are defined with respect to a right hand of the user in one embodiment of this disclosure.

[FIG. 9] A block diagram for illustrating an example of a hardware configuration of a server in one embodiment of this disclosure.

[FIG. 10] A block diagram for illustrating a computer in one embodiment of this disclosure in terms of its module configuration.

[FIG. 11] A sequence chart for illustrating a part of processing to be executed by an HMD set in one embodiment of this disclosure.

[FIG. 12A] Schematic diagrams for illustrating a situation in which each HMD provides the user with the virtual space in a network.

[FIG. 12B] A diagram for illustrating a field-of-view image of a user 5A in FIG. 12A.

[FIG. 13] A sequence diagram for illustrating processing to be executed by the HMD system in one embodiment of this disclosure.

[FIG. 14] A block diagram for illustrating a detailed configuration of modules of the computer in one embodiment of this disclosure.

[FIG. 15] A diagram for illustrating a face image of the user photographed by a first camera.

[FIG. 16] A diagram for illustrating processing (part 1) in which a motion detection module detects the shape of a mouth.

[FIG. 17] A diagram for illustrating processing (part 2) in which the motion detection module detects the shape of the mouth.

[FIG. 18A] A diagram for illustrating a facial expression of the user in a real space.

[FIG. 18B] A diagram for illustrating a facial expression of an avatar object of the user in the virtual space.

[FIG. 19] A diagram for illustrating an example of a hardware configuration and a module configuration of a server.

[FIG. 20] A flowchart for illustrating exchange of signals between the computer and the server for reflecting a motion by the user in an avatar object.

[FIG. 21A] A diagram for illustrating processing for detecting a tongue in an embodiment of this disclosure.

[FIG. 21B] A diagram for illustrating a field-of-view image to be visually recognized by the user.

[FIG. 22] A flowchart for illustrating control in which a processor detects the tongue.

[FIG. 23A] A diagram for illustrating a processing example of Step S2240 of FIG. 22.

[FIG. 23B] A diagram for illustrating a processing example of Step S2240 of FIG. 22.

[FIG. 24] A flowchart for illustrating a processing example of Step S2250 of FIG. 22.

[FIG. 25] A diagram for illustrating processing for detecting an amount by which the user is protruding his or her tongue.

[FIG. 26] A flowchart for illustrating processing in which the processor controls the amount by which the avatar object is to protrude its tongue.

### DESCRIPTION OF EMBODIMENTS

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

### [Configuration of HMD System]

With reference to FIG. 1, a configuration of a head-mounted device (HMD) system 100 is described. FIG. 1 is a diagram for illustrating an overview of the configuration of the HMD system 100 in one embodiment of this disclosure. The HMD system 100 is provided as a system for household use or a system for professional use.

The HMD system 100 includes a server 600, HMD sets 110A, 110B, 110C, and 110D, an external device 700, and a network 2. Each of the HMD sets 110A, 110B, 110C, and 110D is capable of communicating to/from the server 600 or the external device 700 via the network 2. In the following, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. The controller 300 may include a motion sensor 420.

In one aspect, the computer 200 can be connected to the network 2, for example, the Internet, and can communicate to/from the server 600 or other computers connected to the network 2. Examples of the other computers include a computer of another HMD set 110 and the external device 700. In another aspect, the HMD 120 may include a sensor 190 instead of the HMD sensor 410.

The HMD 120 may be worn on a head of a user 5 to provide a virtual space to the user 5 during operation. More specifically, the HMD 120 displays each of a right-eye image and a left-eye image on the monitor 130. When each eye of the user 5 visually recognizes each image, the user 5 may recognize the image as a three-dimensional image based on the parallax of both the eyes. The HMD 120 may include any one of a so-called head-mounted display including a monitor and a head-mounted device capable of mounting a smartphone or other terminals including a monitor.

The monitor 130 is implemented as, for example, a non-transmissive display device. In one aspect, the monitor 130 is arranged on a main body of the HMD 120 so as to be positioned in front of both the eyes of the user 5. Therefore, when the user 5 visually recognizes the three-dimensional image displayed on the monitor 130, the user 5 can be immersed in the virtual space. In one aspect, the virtual space includes, for example, a background, objects that can be operated by the user 5, and menu images that can be selected by the user 5. In one aspect, the monitor 130 may be implemented as a liquid crystal monitor or an organic electroluminescence (EL) monitor included in a so-called smartphone or other information display terminals.

In another aspect, the monitor 130 may be implemented as a transmissive display device. In this case, the HMD 120 is not a non-see-through HMD covering the eyes of the user 5 illustrated in FIG. 1, but maybe a see-through HMD, for example, smartglasses. The transmissive monitor 130 may be configured as a temporarily non-transmissive display device through adjustment of a transmittance thereof. The monitor 130 may be configured to display a real space and a part of an image constructing the virtual space at the same time. For example, the monitor 130 may display an image of the real space captured by a camera mounted on the HMD 120, or may enable recognition of the real space by setting the transmittance of a part the monitor 130 high.

In one aspect, the monitor 130 may include a sub-monitor for displaying a right-eye image and a sub-monitor for displaying a left-eye image. In another aspect, the monitor 130 may be configured to integrally display the right-eye image and the left-eye image. In this case, the monitor 130 includes a high-speed shutter. The high-speed shutter operates so as to enable alternate display of the right-eye image and the left-eye image so that only one of the eyes can recognize the image.

In one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In another aspect, the HMD sensor 410 may be implemented by a camera. In this case, the HMD sensor 410 may use image information of the HMD 120 output from the camera to execute image analysis processing, to thereby enable detection of the position and the inclination of the HMD 120.

In another aspect, the HMD 120 may include the sensor 190 instead of, or in addition to, the HMD sensor 410 as a position detector. The HMD 120 may use the sensor 190 to detect the position and the inclination of the HMD 120 itself. For example, when the sensor 190 is an angular velocity sensor, a geomagnetic sensor, or an acceleration sensor, the HMD 120 may use any of those sensors instead of the HMD sensor 410 to detect the position and the inclination of the HMD 120 itself. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In one aspect, the eye gaze sensor 140 is preferred to include a right-eye sensor and a left-eye sensor. The eye gaze sensor 140 may be, for example, a sensor configured to irradiate the right eye and the left eye of the user 5 with an infrared ray, and to receive reflection light from the cornea and the iris with respect to the irradiation light, to thereby detect a rotational angle of each eyeball. The eye gaze sensor 140 can detect the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In one aspect, the first camera 150 may be arranged outside of the HMD 120, and the second camera 160 may be arranged inside of the HMD 120. Images generated by the first camera 150 and the second camera 160 are input to the computer 200. In another aspect, the first camera 150 and the second camera 160 may be implemented as one camera, and the face of the user 5 may be photographed with this one camera.

The microphone 170 converts an utterance of the user 5 into a voice signal (electric signal) for output to the computer 200. The speaker 180 converts the voice signal into a voice for output to the user 5. In another aspect, the HMD 120 may include earphones in place of the speaker 180.

The controller 300 is connected to the computer 200 through wired or wireless communication. The controller 300 receives input of a command from the user 5 to the computer 200. In one aspect, the controller 300 can be held by the user 5. In another aspect, the controller 300 can be mounted to the body or a part of the clothes of the user 5. In still another aspect, the controller 300 may be configured to output at least any one of a vibration, a sound, or light based on the signal transmitted from the computer 200. In yet another aspect, the controller 300 receives from the user 5 an operation for controlling the position and the motion of an object arranged in the virtual space.

In one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In another aspect, the HMD sensor 410 may be implemented by a camera. In this case, the HMD sensor 410 may use image information of the controller 300 output from the camera to execute image analysis processing, to thereby enable detection of the position and the inclination of the controller 300.

In one aspect, the motion sensor 420 is mounted on the hand of the user 5 to detect the motion of the hand of the user 5. For example, the motion sensor 420 detects a rotational speed and the number of rotations of the hand. The detected signal is transmitted to the computer 200. The motion sensor 420 is provided to, for example, the controller 300. In one aspect, the motion sensor 420 is provided to, for example, the controller 300 capable of being held by the user 5. In another aspect, for the safety in the real space, the controller 300 is mounted on an object like a glove-type object that does not easily fly away by being worn on a hand of the user 5. In still another aspect, a sensor that is not mounted on the user 5 may detect the motion of the hand of the user 5. For example, a signal of a camera that photographs the user 5 may be input to the computer 200 as a signal representing the motion of the user 5. As one example, the motion sensor 420 and the computer 200 are connected to each other through wireless communication. In the case of wireless communication, the communication mode is not particularly limited, and for example, Bluetooth (trademark) or other known communication methods are used.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

The server 600 may transmit a program to the computer 200. In another aspect, the server 600 may communicate to/from another computer 200 for providing virtual reality to the HMD 120 used by another user. For example, when a plurality of users play a participatory game in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 may be any device as long as the external device 700 can communicate to/from the computer 200. The external device 700 may be, for example, a device capable of communicating to/from the computer 200 via the network 2, or may be a device capable of directly communicating to/from the computer 200 by near field communication or wired communication. Peripheral devices such as a smart device, a personal computer (PC), and the computer 200 may be used as the external device 700, but the external device 700 is not limited thereto.

[Hardware Configuration of Computer]

With reference to FIG. 2, the computer 200 in this embodiment is described. FIG. 2 is a block diagram for illustrating an example of the hardware configuration of the computer 200 in this embodiment. The computer 200 includes, as primary components, a processor 210, a memory 220, a storage 230, an input/output interface 240, and a communication interface 250. Each component is connected to a bus 260.

The processor 210 executes a series of commands included in a program stored in the memory 220 or the storage 230 based on a signal transmitted to the computer 200 or on satisfaction of a condition determined in advance. In one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In one aspect, the memory 220 is implemented as a random access memory (RAM) or other volatile memories.

The storage 230 permanently stores programs and data. The storage 230 is implemented as, for example, a read-only memory (ROM), a hard disk device, a flash memory, or other non-volatile storage devices. The programs stored in the storage 230 include programs for providing a virtual space in the HMD system 100, simulation programs, game programs, user authentication programs, and programs for implementing communication to/from other computers 200. The data stored in the storage 230 includes data and objects for defining the virtual space.

In another aspect, the storage 230 may be implemented as a removable storage device like a memory card. In still another aspect, a configuration that uses programs and data stored in an external storage device may be used instead of the storage 230 built into the computer 200. With such a configuration, for example, in a situation in which a plurality of HMD systems 100 are used as in an amusement facility, the programs and the data can be collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In one aspect, the input/output interface 240 is implemented with use of a universal serial bus (USB), a digital visual interface (DVI), a high-definition multimedia interface (HDMI) (trademark), or other terminals. The input/output interface 240 is not limited to ones described above.

In one aspect, the input/output interface 240 may further communicate to/from the controller 300. For example, the input/output interface 240 receives input of a signal output from the controller 300 and the motion sensor 420. In another aspect, the input/output interface 240 transmits a command output from the processor 210 to the controller 300. The command instructs the controller 300 to, for example, vibrate, output a sound, or emit light. When the controller 300 receives the command, the controller 300 executes anyone of vibration, sound output, and light emission in accordance with the command.

The communication interface 250 is connected to the network 2 to communicate to/from other computers (e.g., server 600) connected to the network 2. In one aspect, the communication interface 250 is implemented as, for example, a local area network (LAN), other wired communication interfaces, wireless fidelity (Wi-Fi), Bluetooth (trademark), near field communication (NFC), or other wireless communication interfaces. The communication interface 250 is not limited to ones described above.

In one aspect, the processor 210 accesses the storage 230 and loads one or more programs stored in the storage 230 to the memory 220 to execute a series of commands included in the program. The one or more programs may include an operating system of the computer 200, an application program for providing a virtual space, and game software that can be executed in the virtual space. The processor 210 transmits a signal for providing a virtual space to the HMD 120 via the input/output interface 240. The HMD 120 displays a video on the monitor 130 based on the signal.

In the example illustrated in FIG. 2, the computer 200 is provided outside of the HMD 120, but in another aspect, the computer 200 may be built into the HMD 120. As an example, a portable information communication terminal (e.g., smartphone) including the monitor 130 may function as the computer 200.

The computer 200 may be used in common among a plurality of HMDs 120. With such a configuration, for example, the same virtual space can be provided to a plurality of users, and hence each user can enjoy the same application with other users in the same virtual space.

According to one embodiment of this disclosure, in the HMD system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which correspond to the motion of the user 5 wearing the HMD 120, based on the value of each point (each coordinate value in the real coordinate system). In more detail, the HMD sensor 410 can detect the temporal change of the position and the inclination of the HMD 120 with use of each value detected over time.

Each inclination of the HMD 120 detected by the HMD sensor 410 corresponds to each inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

With reference to FIG. 3, the uvw visual-field coordinate system is described. FIG. 3 is a diagram for schematically illustrating a uvw visual-field coordinate system to be set for the HMD 120 in one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

As illustrated in FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In one aspect, when the user 5 wearing the HMD 120 is standing upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 can detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is always constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In one aspect, the HMD sensor 410 may identify the position of the HMD 120 in the real space as a position relative to the HMD sensor 410 based on the light intensity of the infrared ray or a relative positional relationship between a plurality of points (e.g., distance between points), which is acquired based on output from the infrared sensor. The processor 210 may determine the origin of the uvw visual-field coordinate system of the HMD 120 in the real space (real coordinate system) based on the identified relative position.

[Virtual Space]

With reference to FIG. 4, the virtual space is further described. FIG. 4 is a diagram for schematically illustrating one mode of expressing a virtual space 11 in one embodiment of this disclosure. The virtual space 11 has a structure with an entire celestial sphere shape covering a center 12 in all 360-degree directions. In FIG. 4, in order to avoid complicated description, only the upper-half celestial sphere of the virtual space 11 is exemplified. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that can be developed in the virtual space 11 with each corresponding mesh section in the virtual space 11.

In one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space maybe reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 can be said to be a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the HMD system 100 in one aspect, the line of sight of the user 5 detected by the eye gaze sensor 140 can be regarded as the line of sight of the user 5 in the uvw visual-field coordinate system of the virtual camera 14.

[User's Line of Sight]

With reference to FIG. 5, determination of the line of sight of the user 5 is described. FIG. 5 is a diagram for illustrating, from above, the head of the user 5 wearing the HMD 120 in one embodiment of this disclosure.

In one aspect, the eye gaze sensor 140 detects lines of sight of the right eye and the left eye of the user 5. In one aspect, when the user 5 is looking at a near place, the eye gaze sensor 140 detects lines of sight R1 and L1. In another aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In another aspect, the HMD system 100 may include a television broadcast reception tuner. With such a configuration, the HMD system 100 can display a television program in the virtual space 11.

In still another aspect, the HMD system 100 may include a communication circuit for connecting to the Internet or have a verbal communication function for connecting to a telephone line.

[Field-Of-View Region]

With reference to FIG. 6 and FIG. 7, the field-of-view region 15 is described. FIG. 6 is a diagram for illustrating a YZ cross section obtained by viewing the field-of-view region 15 from an X direction in the virtual space 11. FIG. 7 is a diagram for illustrating an XZ cross section obtained by viewing the field-of-view region 15 from a Y direction in the virtual space 11.

As illustrated in FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

As illustrated in FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth p from the reference line of sight 16 serving as the center in the virtual space 11 as the region 19. The polar angle a and p are determined in accordance with the position of the virtual camera 14 and the inclination (direction) of the virtual camera 14.

In one aspect, the HMD system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120, the user 5 can visually recognize only the panorama image 13 developed in the virtual space 11 without visually recognizing the real world. Therefore, the HMD system 100 can provide a high sense of immersion in the virtual space 11 to the user 5.

In one aspect, the processor 210 may move the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In one aspect, the virtual camera 14 may include two virtual cameras, that is, a virtual camera for providing a right-eye image and a virtual camera for providing a left-eye image. An appropriate parallax is set for the two virtual cameras so that the user 5 can recognize the three-dimensional virtual space 11. In another aspect, the virtual camera 14 may be implemented by one virtual camera. In this case, a right-eye image and a left-eye image may be generated from an image acquired by one virtual camera. In this embodiment, the technical idea of this disclosure is exemplified assuming that the virtual camera 14 includes two virtual cameras, and the roll axes of the two virtual cameras are synthesized so that the generated roll axis (w) is adapted to the roll axis (w) of the HMD 120.

[Controller]

An example of the controller 300 is described with reference to FIGS. 8. FIGS. 8 are diagrams for illustrating a schematic configuration of the controller 300 in one embodiment of this disclosure.

As illustrated in FIGS. 8, in one aspect, the controller 300 may include a right controller 300R and a left controller (not shown). The right controller 300R is operated by the right hand of the user 5. The left controller is operated by the left hand of the user 5. In one aspect, the right controller 300R and the left controller are symmetrically configured as separate devices. Therefore, the user 5 can freely move his or her right hand holding the right controller 300R and his or her left hand holding the left controller. In another aspect, the controller 300 may be an integrated controller configured to receive an operation performed by both hands. The right controller 300R is now described.

The right controller 300R includes a grip 310, a frame 320, and a top surface 330. The grip 310 is configured so as to be held by the right hand of the user 5. For example, the grip 310 may be held by the palm and three fingers (middle finger, ring finger, and small finger) of the right hand of the user 5.

The grip 310 includes buttons 340 and 350 and the motion sensor 420. The button 340 is arranged on a side surface of the grip 310, and receives an operation performed by the middle finger of the right hand. The button 350 is arranged on a front surface of the grip 310, and receives an operation performed by the index finger of the right hand. In one aspect, the buttons 340 and 350 are configured as trigger type buttons. The motion sensor 420 is built into the casing of the grip 310. When a motion of the user 5 can be detected from the surroundings of the user 5 by a camera or other device, it is not required for the grip 310 to include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 may be used to detect the position and the posture (inclination and direction) of each of the right controller 300R and the left controller. In the example illustrated in FIGS. 8, the infrared LEDs 360 are shown as being arranged in two rows, but the number of arrangement rows is not limited to that illustrated in FIGS. 8. The infrared LEDs 360 may be arranged in one row or in three or more rows.

The top surface 330 includes buttons 370 and 380 and an analog stick 390. The buttons 370 and 380 are configured as push type buttons. The buttons 370 and 380 receive an operation performed by the thumb of the right hand of the user 5. In one aspect, the analog stick 390 receives an operation performed in any direction of 360 degrees from an initial position (neutral position). The operation includes, for example, an operation for moving an object arranged in the virtual space 11.

In one aspect, each of the right controller 300R and the left controller includes a battery for driving the infrared ray LEDs 360 and other members. The battery includes, for example, a rechargeable battery, a button battery, a dry battery, but the battery is not limited thereto. In another aspect, the right controller 300R and the left controller may be connected to, for example, a USB interface of the computer 200. In this case, the right controller 300R and the left controller do not require a battery.

In FIG. 8A and FIG. 8B, for example, a yaw direction, a roll direction, and a pitch direction are defined with respect to the right hand of the user 5. A direction of extending the thumb, a direction of extending the index finger, and a direction perpendicular to a plane defined by the yaw-direction axis and the roll-direction axis when the user 5 extends his or her thumb and index finger are defined as the yaw direction, the roll direction, and the pitch direction, respectively.

[Hardware Configuration of Server]

With reference to FIG. 9, the server 10 in this embodiment is described. FIG. 9 is a block diagram for illustrating an example of a hardware configuration of the server 600 in one embodiment of this disclosure. The server 600 includes, as primary components, a processor 610, a memory 620, a storage 630, an input/output interface 640, and a communication interface 650. Each component is connected to a bus 660.

The processor 610 executes a series of commands included in a program stored in the memory 620 or the storage 630 based on a signal transmitted to the server 600 or on satisfaction of a condition determined in advance. In one aspect, the processor 10 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In one aspect, the memory 620 is implemented as a random access memory (RAM) or other volatile memories.

The storage 630 permanently stores programs and data. The storage 630 is implemented as, for example, a read-only memory (ROM), a hard disk device, a flash memory, or other non-volatile storage devices. The programs stored in the storage 630 include programs for providing a virtual space in the HMD system 100, simulation programs, game programs, user authentication programs, and programs for implementing communication to/from other computers 200. The data stored in the storage 630 may include, for example, data and objects for defining the virtual space.

In another aspect, the storage 630 may be implemented as a removable storage device like a memory card. In another aspect, a configuration that uses programs and data stored in an external storage device may be used instead of the storage 630 built into the server 600. With such a configuration, for example, in a situation in which a plurality of HMD systems 100 are used as in an amusement facility, the programs and the data can be collectively updated.

The input/output interface 640 allows communication of signals to/from an input/output device. In one aspect, the input/output interface 640 is implemented with use of a USB, a DVI, an HDMI, or other terminals. The input/output interface 640 is not limited to ones described above.

The communication interface 650 is connected to the network 2 to communicate to/from the computer 200 connected to the network 2. In one aspect, the communication interface 650 is implemented as, for example, a LAN, other wired communication interfaces, Wi-Fi, Bluetooth, NFC, or other wireless communication interfaces. The communication interface 650 is not limited to ones described above.

In one aspect, the processor 610 accesses the storage 630 and loads one or more programs stored in the storage 630 to the memory 620 to execute a series of commands included in the program. The one or more programs may include, for example, an operating system of the server 610, an application program for providing a virtual space, and game software that can be executed in the virtual space. The processor 610 may transmit a signal for providing a virtual space to the HMD device 110 to the computer 200 via the input/output interface 640.

[Control Device of HMD]

With reference to FIG. 10, the control device of the HMD 21 is described. According to one embodiment of this disclosure, the control device is implemented by the computer 200 having a known configuration. FIG. 10 is a block diagram for illustrating the computer 200 in one embodiment of this disclosure in terms of its module configuration.

As illustrated in FIG. 10, the computer 200 includes a control module 510, a rendering module 520, a memory module 530, and a communication control module 540. In one aspect, the control module 510 and the rendering module 520 are implemented by the processor 210. In another aspect, a plurality of processors 210 may actuate as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. The control module 510 may generate virtual space data by itself or acquire virtual space data from, for example, the server 600.

The control module 510 arranges objects in the virtual space 11 using object data representing objects. The object data is stored in, for example, the memory module 530. The control module 510 may generate virtual space data by itself or acquire object data from, for example, the server 600. The objects may include, for example, an avatar object of the user 5, character objects, operation objects, for example, a virtual hand to be operated by the controller 300, and forests, mountains, other landscapes, streetscapes, and animals to be arranged in accordance with the progression of the story of the game.

The control module 510 arranges an avatar object of the user 5 of another computer 200, which is connected via the network 2, in the virtual space 11. In one aspect, the control module 510 arranges an avatar object of the user 5 in the virtual space 11. In one aspect, the control module 510 arranges an avatar object simulating the user 5 in the virtual space 11 based on an image including the user 5. In another aspect, the control module 510 arranges an avatar object in the virtual space 2, which is selected by the user 5 from among a plurality of types of avatar objects (e.g., objects simulating animals or objects of deformed humans).

The control module 510 identifies an inclination of the HMD 120 based on output of the HMD sensor 410. In another aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In another aspect, the control module 510 may be configured to transmit line-of-sight information representing the line of sight of the user 5 to the server 600. In such a case, the control module 510 may calculate the point-of-view position based on the line-of-sight information received by the server 600.

The control module 510 reflects a motion of the HMD 120, which is detected by the HMD sensor 410, in an avatar object. For example, the control module 510 detects inclination of the HMD 120, and arranges the avatar object in an inclined manner. The control module 510 reflects the detected motion of face parts in a face of the avatar object arranged in the virtual space 11. The control module 510 receives line-of-sight information of another user 5 from the server 600, and reflects the line-of-sight information in the line of sight of the avatar object of another user 5. In one aspect, the control module 510 reflects a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In one aspect, the operation object may include, for example, a hand object serving as a virtual hand corresponding to a hand of the user 5. In one aspect, the control module 510 moves the hand object in the virtual space 11 so that the hand object moves in association with a motion of the hand of the user 5 in the real space based on output of the motion sensor 420. In one aspect, the operation object may correspond to a hand part of an avatar object.

When one object arranged in the virtual space 11 collides with another object, the control module 510 detects the collision. The control module 510 can detect, for example, a timing at which a collision area of one object and a collision area of another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. For example, when an operation object touches with another object, the control module 510 detects the fact that the operation object has touched with another object, and performs predetermined processing.

In one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 510 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs voices (utterances) corresponding to the voice data from the speaker 180.

The memory module 530 holds data to be used to provide the virtual space 11 to the user 5 by the computer 200. In one aspect, the memory module 530 holds space information, object information, and user information.

The space information holds one or more templates defined to provide the virtual space 11.

The object information stores a plurality of panorama images 13 forming the virtual space 11 and object data for arranging objects in the virtual space 11. The panorama image 13 may contain a still image and a moving image. The panorama image 13 may contain an image in a non-real space and an image in the real space. An example of the image in a non-real space is an image generated by computer graphics.

The user information stores a user ID for identifying the user 5. The user ID may be, for example, an internet protocol (IP) address or a media access control (MAC) address set to the computer 200 used by the user. In another aspect, the user ID maybe set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

The communication control module 540 may communicate to/from the server 600 or other information communication devices via the network 2.

In one aspect, the control module 510 and the rendering module 520 may be implemented with use of, for example, Unity (trademark) provided by Unity Technologies. In another aspect, the control module 510 and the rendering module 520 may also be implemented by combining the circuit elements for implementing each step of processing.

The processing performed in the computer 200 is implemented by hardware and software executed by the processor 410. The software may be stored in advance on a hard disk or other memory module 530. The software may also be stored on a CD-ROM or other computer-readable non-volatile data recording media, and distributed as a program product. The software may also be provided as a program product that can be downloaded by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

With reference to FIG. 11, the control structure of the HMD set 110 is described. FIG. 11 is a sequence chart for illustrating a part of processing to be executed by the HMD system 100 in one embodiment of this disclosure.

As illustrated in FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In another aspect, an operation of the controller 300 by the user 5 may be detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

With reference to FIG. 12(A) and FIG. 12(B), an avatar object in this embodiment is described. FIG. 12(A) and FIG. 12(B) are diagrams for illustrating avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12(A) is a schematic diagram for illustrating a situation in which each HMD 120 provides the user 5 with the virtual space 11. Computers 200A to 200D provide the users 5A to 5D with virtual spaces 11A to 11D via HMDs 120A to 120D, respectively. In the example illustrated in FIG. 12(A), the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, this illustration is only for the sake of simplicity of description, and those objects do not wear the HMD 120 in actuality.

In one aspect, the processor 210A may arrange a virtual camera 14A for photographing a field-of-view region 17A of the user 5A at the position of eyes of the avatar object 6A.

FIG. 12(B) is a diagram for illustrating the field-of-view region 17A of the user 5A in FIG. 12(A). The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not particularly illustrated in FIG. 12B, the avatar object 6A of the user 5A is displayed in the field-of-view image of the user 5B.

Under the state of FIG. 12(B), the user 5A can communicate to/from the user 5B via the virtual space 11A through conversation. More specifically, voices of the user 5A acquired by a microphone 170A are transmitted to the HMD17120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A reflects an operation by the user 5B (operation of HMD 120B and operation of controller 300B) in the avatar object 6B arranged in the virtual space 11A. With this, the user 5A can recognize the operation by the user 5B through the avatar object 6B.

FIG. 13 is a sequence chart for illustrating a part of processing to be executed by the HMD system 100 in this embodiment. In FIG. 13, although the HMD set 110D is not illustrated, the HMD set 110D operates in the same manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. The avatar information may contain information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210B of the HMD set 110B acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD11020C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 540. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Details of Module Configuration]

With reference to FIG. 14, details of a module configuration of the computer 200 are described. FIG. 14 is a block diagram for illustrating details of the module configuration of the computer 200 in one embodiment of this disclosure.

As illustrated in FIG. 14, the control module 510 includes a virtual camera control module 1421, a field-of-view region determination module 1422, a reference-line-of-sight identification module 1423, a face part detection module 1424, a motion detection module 1425, a virtual space definition module 1426, a virtual object generation module 1427, an operation object control module 1428, and an avatar control module 1429. The rendering module 520 includes a field-of-view image generation module 1438. The memory module 530 stores space information 1431, object information 1432, user information 1433, and face information 1434.

The virtual camera control module 1421 arranges the virtual camera 14 in the virtual space 11. The virtual camera control module 1421 controls a position in the virtual space 11 at which the virtual camera 14 is arranged and the direction (inclination) of the virtual camera 14. The field-of-view region determination module 1432 determines the visually-recognized region 15 based on the direction of the head of the user wearing the HMD 120 and the position at which the virtual camera 14 is arranged. The field-of-view image generation module 1438 generates the field-of-view region 17 to be displayed on the monitor 130 based on the determined visually-recognized region 15.

The reference-line-of-sight identification module 1423 identifies the line of sight of the user 5 based on a signal from the eye gaze sensor 140. The face part detection module 1424 detects parts (e.g., mouth, eyes, and eyebrows) forming the face of the user 5 from the face image of the user 5 generated by the first camera 150 and the second camera 160. The motion detection module 1425 detects a motion (shape) of each part detected by the face part detection module 1424. Details of control of the face part detection module 1424 and the motion detection module 1425 are described later with reference to FIG. 15 to FIG. 17.

The control module 510 controls the virtual space 11 provided to the user 5. The virtual space definition module 1426 generates virtual space data representing the virtual space 11, to thereby define the virtual space 11 in the HMD system 100.

The virtual object generation module 1427 generates objects to be arranged in the virtual space 11. The objects may include, for example, forests, mountains, other landscapes, and animals to be arranged in accordance with the progression of the story of the game.

The operation object control module 1428 arranges, in the virtual space 11, an operation object for receiving an operation of the user 5 in the virtual space 11. The user operates the operation object to operate an object arranged in the virtual space 11, for example. In one aspect, the operation object may include, for example, a hand object corresponding to the hand of the user wearing the HMD 120. In one aspect, the operation object may correspond to a hand part of an avatar object described later.

The avatar control module 1429 generates data for generating an avatar object of the user of another computer 200, which is connected via the network, and arranging the avatar object in the virtual space 11. In one aspect, the avatar control module 1429 generates data for arranging an avatar object of the user 5 in the virtual space 11. In one aspect, the avatar control module 1429 generates an avatar object simulating the user 5 based on an image including the user 5. In another aspect, the avatar control module 1429 generates data for arranging an avatar object in the virtual space 11, which is selected by the user 5 from among a plurality of types of avatar objects (e.g., objects simulating animals or objects of deformed humans).

The avatar control module 1429 reflects a motion of the HMD 120, which is detected by the HMD sensor 420, in an avatar object. For example, the avatar control module 1429 detects inclination of the HMD 120, and generates data for arranging the avatar object in an inclined manner. In one aspect, the avatar control module 1429 reflects a motion of the controller 300 in an avatar object. In this case, to the controller 300, for example, a motion sensor, an acceleration sensor, or a plurality of light emitting elements (e.g., infrared LEDs) for detecting a motion of the controller 300 are mounted. The avatar control module 1429 reflects motions of face parts detected by the motion detection module 1425 in the face of an avatar object arranged in the virtual space 11.

The space information 1431 stores one or more templates that are defined to provide the virtual space 11.

The object information 1432 stores content to be reproduced in the virtual space 11, objects to be used in the content, and information (e.g., positional information) for arranging objects in the virtual space 11. The content may include, for example, game content and content representing landscapes that resemble those of the real society.

The user information 1433 stores, for example, a program for causing the computer 200 to function as a control device for the HMD set 110 and an application program that uses each piece of content stored in the object information 1432.

The face template 1434 stores a template that is prepared in advance for the face part detection module 1424 to detect face parts of the user 5. In one embodiment, the face template 1434 stores a mouth template 1435, an eye template 1436, and an eyebrow template 1437. The mouth template 1435 includes an upper lip template 1435-1, a lower lip template 1435-2, and a tongue template 1435-3. Each template may be an image corresponding to each of parts forming a face. For example, the mouth template 1435 may be an image of a mouth. Each template may include a plurality of images.

[Face Tracking]

In the following, with reference to FIG. 15 to FIG. 17, a specific example of detecting a motion (shape) of the face of the user is described. In FIG. 15 to FIG. 17, a specific example of detecting a motion of the mouth of the user is described as an example. The detection method described with reference to FIG. 15 to FIG. 17 is not limited to detection of a motion of the mouth of the user, but may be applied to detection of motions of other parts (e.g., eyes or eyebrows) forming the face of the user.

FIG. 15 is an illustration of a face image 1541 of the user photographed by the first camera 150. The face image 1541 includes the nose and the mouth of the user 5.

The face part detection module 1424 identifies a mouth region 1542 from the facial image 1541 by pattern matching using the mouth template 1435 stored in the face template 1434. In one aspect, the face part detection module 1424 sets a rectangular comparison region in the facial image 1541, and changes the size, position, and angle of this comparison region to calculate a similarity degree between an image of the comparison region and an image of the mouth template 1435. The face part detection module 1424 may identify, as the mouth region 1542, a comparison region for which a similarity degree larger than a threshold value determined in advance is calculated.

The face part detection module 1424 may further determine whether or not the comparison region corresponds to the mouth region based on a relative positional relationship between positions of other face parts (e.g., eyes and nose) and the position of the comparison region for which the calculated similarity degree is larger than the threshold value.

The motion detection module 1425 detects a more detailed shape of the mouth from the mouth region 1542 detected by the face part detection module 1424.

FIG. 16 is an illustration of processing (part 1) in which the motion detection module 1425 detects the shape of the mouth. With reference to FIG. 16, the motion detection module 1425 sets a contour detection line 1643 for detecting the shape of the mouth (contour of lips) contained in the mouth region 1542. A plurality of contour detection lines 1643 are set at predetermined intervals in a direction (hereinafter referred to as “lateral direction”) orthogonal to a height direction (hereinafter referred to as “longitudinal direction”) of the face.

The motion detection module 1425 may detect change in brightness value of the mouth region 1542 along each of the plurality of contour detection lines 1643, and identify a position at which the change in brightness value is abrupt as a contour point. More specifically, the motion detection module 1425 may identify, as the contour point, a pixel for which a brightness difference (namely, change in brightness value) between the pixel and an adjacent pixel is equal to or larger than a threshold value determined in advance. The brightness value of a pixel is obtained by, for example, integrating RBG values of the pixel with predetermined weighting.

The motion detection module 1425 identifies two types of contour points from the image corresponding to the mouth region 1542. The motion detection module 1425 identifies a contour point 1644 corresponding to a contour of the outer side of the mouth (lips) and a contour point 1645 corresponding to a contour of the inner side of the mouth (lips). In one aspect, when three or more contour points are detected on one contour detection line 1643, the motion detection module 1425 may identify contour points on both ends of the contour detection line 1643 as the outer contour points 1644. In this case, the motion detection module 1425 may identify contour points other than the outer contour points 1644 as the inner contour points 1645. When two or less contour points are detected on one contour detection line 1643, the motion detection module 1425 may identify the detected contour points as the outer contour points 1644.

FIG. 17 is an illustration of processing (part 2) in which the motion detection module 1425 detects the shape of the mouth.

In FIG. 17, the outer contour points 1644 and the inner contour points 1645 are indicated by white circles and hatched circles, respectively.

The motion detection module 1425 interpolates points between the inner contour points 1645 to identify a mouth shape 1746 (size of mouth opening). In one aspect, the motion detection module 1425 may identify the mouth shape 1746 with use of a nonlinear interpolation method, for example, spline interpolation. In another aspect, the motion detection module 1425 may identify the mouth shape 1746 by interpolating points between the outer contour points 1644. Instill another aspect, the motion detection module 1425 may identify the mouth shape 1746 by removing contour points that greatly deviate from an assumed mouth shape (predetermined shape that maybe formed by upper lip and lower lip of person) and using left contour points. In this manner, the motion detection module 1425 may identify a motion (shape) of the mouth of the user. The method of detecting the mouth shape 1746 is not limited to the above, and the motion detection module 1425 may detect the mouth shape 1746 with another method. The motion detection module 1425 may detect motions of other face parts of eyes and eyebrows of the user in the same manner.

The motion detection module 1425 may also detect the upper lip and the lower lip that form the mouth. As an example, the motion detection module 1425 identifies, among contour points 1644, a contour point 1644-R and a contour point 1644-L present at both ends in the lateral direction. The motion detection module 1425 may detect, as the lower lip, a region 1747 surrounded by those contour points present at both ends and the inner contour points 1645 and may outer contour points 1644 present on a lower side in the up-down direction from the contour points present at both ends. The motion detection module 1425 may detect, as the upper lip, a region surrounded by the outer contour points 1644-R and 1644-L present at both ends and the inner contour points 1645 and the outer contour points 1644 present on an upper side in the up-down direction from the contour points present at both ends.

In another aspect, the facial organ detection module 1424 may detect the lower lip of the user 5 from the image 1541 by performing pattern matching between the image 1541 photographed by the first camera 150 and the lower lip template 1435-2 stored in the memory module 530. More specifically, the facial organ detection module 1424 may detect, as the lower lip, a comparison region included in the image 1541 and having a higher similarity with the lower lip template 1435-2 than a threshold value determined in advance. The facial organ detection module 1424 may detect the upper lip of the user 5 from the image 1541 by performing pattern matching between the image 1541 and the upper lip template 1435-1 in the same manner as in the lower lip detection method.

FIG. 18A and FIG. 18B are illustrations of comparison between a facial expression of the user in the real space and a facial expression of the avatar object of the user in the virtual space. FIG. 18A is an illustration of the user 5B in the real space. FIG. 18B is an illustration of a field-of-view image 1817A to be visually recognized by the user 5A.

With reference to FIG. 18A, the first camera 150B and the second camera 160B constructing the HMD set 110B photograph the user 5B. The user 5B is smiling at the time of photography. In FIG. 18A, the user is wearing the HMD 120B, but the HMD 120B is omitted for the sake of convenience. The same holds true for similar diagrams described later.

The motion detection module 1425B detects the shape of the mouth of the user 5B based on an image photographed by the first camera 150B. The computer 200B outputs data representing the detected shape (motion) of the mouth to the server 600. The server 600 transfers the data to the computer 200A, which shares the same virtual space 11 as that of the computer 200B. An avatar control module 1429A reflects the shape of the mouth of the user 5B in the avatar object 6B based on the data. With this, as illustrated in FIG. 18B, the avatar object 6B displayed on the field-of-view image 1817A of the user 5A represents a facial expression of smiling.

[Control Structure of Server 600]

FIG. 19 is an illustration of an example of a hardware configuration and a module configuration of the server 600. In one embodiment of this disclosure, the server 600 includes, as primary components, the communication interface 650, the processor 610, and the storage 630.

The communication interface 650 functions as a communication module for wireless communication, which is configured to perform, for example, modulation/demodulation processing for transmitting/receiving signals to/from an external communication device, for example, the computer 200. The communication interface 650 is implemented by, for example, a tuner or a high frequency circuit.

The processor 610 controls operation of the server 600. The processor 610 executes various control programs stored in the storage 630 to function as a transmission/reception unit 1951, a server processing unit 1952, and a matching unit 1953.

The transmission/reception unit 1951 transmits/receives various kinds of information to/from each computer 200. For example, the transmission/reception unit 1951 transmits to each computer 200 a request for arranging objects in the virtual space 11, a request for deleting objects from the virtual space 11, a request for moving objects, voices of the user, or information for defining the virtual space 11.

The server processing unit 1952 performs processing required for a plurality of users to share the same virtual space 11. For example, the server processing unit 1952 updates avatar object information 1956 described later based on the information received from the computer 200.

The matching unit 1953 performs a series of processing for associating a plurality of users with one another. For example, when an input operation for the plurality of users to share the same virtual space 11 is performed, the matching unit 1953 performs, for example, processing for associating users belonging to the virtual space 11 to one another.

The storage 630 stores virtual space designation information 1954, object designation information 1955, the avatar object information 1956, and user information 1959.

The virtual space designation information 1954 is information to be used by the virtual space definition module 1426 of the computer 200 to define the virtual space 11. For example, the virtual space designation information 1954 contains information for designating the size of the virtual space 11.

The object designation information 1955 designates an object to be arranged (generated) by the virtual object generation module 1427 of the computer 200 in the virtual space 11.

The avatar object information 1956 contains face information 1957 and position information 1958. The face information 1957 is information (face tracking data) representing a motion (shape) of each part (e.g., mouth, eyes, and eyebrows) forming the face of the user of the computer 200. The position information 1958 represents a position (coordinates) of each avatar object in the virtual space 11. The avatar object information 1956 maybe updated as appropriate based on information input from the computer 200.

The user information 1959 is information on the user 5 of the computer 200. The user information 1959 contains, for example, identification information (e.g., user account) identifying the plurality of users 5.

[Control for Reflecting Operation of User in Avatar Object]

With reference to FIG. 20, a method of controlling operation of an avatar object in the virtual space is described. FIG. 20 is a flowchart for illustrating exchange of signals between the computer 200 and the server 600 for reflecting a motion of the user in the avatar object. The processing illustrated in FIG. 20 may be implemented by the processor 210 of the computer 200 executing a control program stored in the memory 220 or the storage 230 and the processor 610 of the server 600 executing a control program stored in the storage 630.

In Step S2002, the processor 610 of the server 600 serves as the transmission/reception unit 1951 to transmit the virtual space designation information 1954 to the computers 200A and 200B based on requests for generating the virtual space 11, which are received from the computers 200A and 200B. At this time, each computer 200 may transmit identification information on the user 5 to the server 600 together with the virtual space designation information 1954. Then, the processor 610 may serve as the matching unit 1953 to associate pieces of identification information on the computers 200A and 200B with each other to establish the fact that the users 5A and 6B share the same virtual space.

In Step S2004, the processor 210A of the computer 200A serves as a virtual space definition module 1426A to define the virtual space 11A based on the received virtual space designation information 1954. In Step S2006, similarly to the processor 210A, the processor 210B of the computer 200B defines the virtual space 11B.

In Step S2008, the processor 610 outputs the object designation information 1955 for designating objects to be arranged in the virtual spaces 11A and 11B to the computers 200A and 200B.

In Step S2010, the processor 210A serves as a virtual object generation module 1427A to arrange objects in the virtual space 11A based on the received object designation information 1955. In Step S2012, the processor 210B arranges objects in the virtual space 11B similarly to the processor 210A.

In Step S2014, the processor 210A serves as an avatar control module 1429A to arrange the avatar object 6A (denoted by “own avatar object” in FIG. 20) of the user 5A himself or herself in the virtual space 11A. Then, the processor 210A transmits information (e.g., data for modeling and positional information) on the avatar object 6A to the server 600.

In Step S2016, the processor 610 stores the received information on the avatar object 6A into the storage 630 (avatar object information 1956). The processor 610 further transmits the information on the avatar object 6A to the computer 200B sharing the same virtual space with the computer 200A.

In Step S2018, the processor 210B serves as an avatar control module 1429B to arrange the avatar object 6A in the virtual space 11B based on the received information on the avatar object 6A.

Similarly to Step S2014 to Step S2018, in Step S2020 to Step S2024, the avatar object 6B is generated in the virtual spaces 11A and 11B (denoted by “another avatar object” in FIG. 20), and information on the avatar object 6B is stored in the storage 630.

In Step S2026, the processor 210A photographs the face of the user 5A with the first camera 150A and the second camera 160A to generate a facial image.

In Step S2028, the processor 210A serves as the face part detection module 1424A and the motion detection module 1425A to detect face tracking data representing a motion (shape) of the face (e.g., mouth, eyes, and eyebrows) of the user 5A. The processor 210A further transmits the detected face tracking data to the server 600.

In Step S2030, the processor 210A serves as the avatar control module 1429A to reflect the detected motion of the face of the user 5A in an avatar object 900A arranged in the virtual space 11A.

In Step S2032 to Step S2036, similarly to Step S2026 to Step S2030, the processor 210B reflects a motion of the face of the user 5B in an avatar object 900B based on the facial images generated by the first camera 150B and the second camera 160B. The processor 210B transmits face tracking data representing the motion of the face of the user 5B to the server 600.

In Step S2038, the processor 610 serves as the server processing unit 1952 to update the face information 1957 corresponding to the avatar object 6A based on the face tracking data received from the computer 200A. The processor 610 further updates the face information 1957 corresponding to the avatar object 900B based on the face tracking data received from the computer 200B.

In Step S2038, the processor 610 further serves as the transmission/reception unit 1951 to transmit the face tracking data received from the computer 200A to the computer 200B. The processor 610 transmits the face tracking data received from the computer 200B to the computer 200A.

In Step S2040, the processor 210A serves as the avatar control module 1429A to reflect a motion of the face of the user 5B in the avatar object 6B based on the face tracking data received from the server 600.

In Step S2042, the processor 210B serves as the avatar control module 1429B to reflect a motion of the face of the user 5A in the avatar object 6A based on the face tracking data received from the server 600.

In Step S2044, the processor 210A moves the avatar object 6A. “Movement” in this step includes changing the coordinate position of an avatar object and changing the direction (inclination) of the avatar object. As an example, the processor 210A receives, from the controller 300, input of an instruction to move the own avatar object 6A. As another example, the processor 210A moves the avatar object 6A based on the positional information on the HMD 120 detected by the HMD sensor 420. In Step S2044, the processor 210A further transmits the positional information on the avatar object 6A in the virtual space 11A to the server 600. In another aspect, the processor 210A may be configured to transmit information representing the movement amount of the avatar object 6A to the server 600.

In Step S2046, similarly to the processor 210A, the processor 210B moves the avatar object 6B, and at the same time, transmits the positional information on the avatar object 6B in the virtual space 11B to the server 600.

In Step S2048, the processor 610 serves as the server processing unit 1952 to update the position information 1958 corresponding to the avatar object 6A based on the positional information received from the computer 200A. The processor 610 further updates the position information 1958 corresponding to the avatar object 6B based on the positional information received from the computer 200B.

In Step S2048, the processor 610 further serves as the transmission/reception unit 1951 to transmit the positional information received from the computer 200A to the computer 200B. The processor 610 transmits the positional information received from the computer 200B to the computer 200A.

In Step S2050, the processor 210A serves as the avatar control module 1429A to move the avatar object 6B based on the received positional information. In Step S2052, the processor 210B serves as the avatar control module 1429B to move the avatar object 6A based on the received positional information.

In Step S2054, the processor 210A displays, on the monitor 130A, an image photographed by the virtual camera 14A arranged at the position of the eyes of the avatar object 6A. As a result, a field-of-view image visually recognized by the user 5A is updated. After that, the processor 210A returns the processing to Step S2026.

In Step S2056, similarly to the processor 210A, the processor 210B displays an image photographed by the virtual camera 14B on the monitor 130B. With this, a field-of-view image visually recognized by the user 5B is updated. After that, the processor 210B returns the processing to Step S2032.

In one embodiment of this disclosure, the processing of Step S2026 to S2056, which is executed repeatedly, may be executed at an interval of 1/60 second or 1/30 second.

Through a series of processing steps described above, the user 5 can understand the facial expression of a partner via an avatar object of the partner.

In another aspect, the above-mentioned repeatedly executed processing may include processing for transmitting voices of the user 5 to the computer 200 of the partner and other processing for enhancing communication between users in the virtual space 11.

In the example described above, in Step S2014 and in Step S2020, the computer 200 arranges the avatar object 6 of the user in the virtual space 11. In another aspect, the processing in Step S2014 and in Step S2020 may be omitted because the user can communicate to/from a partner as long as the avatar object of the partner is arranged in the virtual space 11.

[Tongue Detection Method]

A method of implementing smoother communication between users in the virtual space is now described. Specifically, there is described a method in which the fact that the user 5 has protruded his or her tongue in the real space is detected, and that motion is reflected in the avatar object 6 arranged in the virtual space.

It is rare for a person to protrude his or her tongue from the mouth during a face-to-face conversation. In general, people sometimes protrude their tongue a little when trying to hide their embarrassment. Therefore, in order to facilitate communication in the virtual space, the computer is required to detect the fact that the user has protruded his or her tongue a little and reflect that motion in the avatar object. However, hitherto, in order for a computer to recognize the tongue of the user by image processing, it has been required for the user to protrude his or her tongue from the mouth by a sufficient amount. In this case, the computer may erroneously detect a tongue slightly protruded by the user as the lower lip, or may fail to detect the tongue at all. Therefore, there is now described a method of accurately detecting that the user is protruding his or her tongue and reflecting that motion in the avatar object even when the user protrudes out his or her tongue a little.

FIG. 21A and FIG. 21B are diagrams for illustrating processing for detecting a tongue in an embodiment of this disclosure. FIG. 21A is an illustration of the mouth of the user 5B, and FIG. 21B is an illustration of a field-of-view image 2117A to be visually recognized by the user 5A.

As illustrated in FIG. 21A, the first camera 150B photographs an image containing the mouth of the user 5B. The mouth of the user 5B includes an upper lip 2161, a lower lip 2162, and a tongue 2163.

The processor 210B executes, based on the image acquired by the first camera 150B, the series of processing steps described with reference to FIG. 15 to FIG. 17 to detect the lower lip 2162 of the user 5B from the image. Then, when the user 5B protrudes the tongue 2163, as illustrated in FIG. 21A, a part of the lower lip 2162 is covered and hidden by the tongue 2163. Through utilization of this characteristic, when at least a part of the detected lower lip 2162 is hidden, the processor 210B determines that the tongue of the user 5B is protruding from the mouth of the user 5B.

When it is determined that the tongue of the user 5B is protruding from the mouth, the processor 210B transmits face tracking data indicating this fact to the server 600. The server 600 updates the face information 1957 corresponding to the avatar object 6B based on the received face tracking data, and transmits this data to the computer 200A sharing the virtual space with the computer 200B. The processor 210A of the computer 200A causes the tongue of the avatar object 6B arranged in the virtual space 11A to protrude from the mouth of the avatar object 6B based on the received face tracking data. As a result, as illustrated in FIG. 21B, the avatar object 6B visually recognized by the user 5A is in a state in which its tongue is protruding.

In the above description, the HMD system 100 determines whether or not the tongue of the user is protruding based on whether or not the lower lip of the user is hidden. Therefore, even when the tongue of the user is only slightly protruding, the fact that the tongue of the user is protruding can be accurately detected. As a result, the HMD system 100 can facilitate communication between users belonging to the virtual space.

[Processing for Reflecting Tongue Motion in Avatar Object]

FIG. 22 is a flowchart for illustrating processing in which the processor 210 detects the tongue. The processing illustrated in FIG. 22 maybe implemented by the processor 210 executing a control program stored in the storage 12.

In Step S2210, the processor 210 defines the virtual space 11 based on the virtual space designation information 1954 received from the server 600.

In Step S2220, the processor 210 arranges the avatar object 6 of the user 5 of the computer 200 in the virtual space 11. The processor 210 also arranges in the virtual space 11 the avatar object of the user of another computer different from the computer 200.

In Step S2230, the processor 210 detects a lower lip of the user 5 based on the image containing the mouth of the user 5, which is generated by the first camera 150.

In Step S2240, the processor 210 determines whether or not at least a part of the detected lower lip of the user 5 is hidden. Details of the control for determining whether or not the lower lip is hidden are described later with reference to FIG. 23.

When the processor 210 determines that at least a part of the lower lip is hidden (YES in Step S2240), the processor 210 advances the processing to Step S2250. Otherwise (NO in Step S2240), the processor 210 returns the processing to Step S2230.

In Step S2250, the processor 210 determines whether or not the object hiding the lower lip is the tongue. Details of this processing are described later with reference to FIG. 24.

When it is determined that the object hiding the lower lip is the tongue (YES in Step S2250), the processor 210 advances the processing to Step S2260. When it is determined that the object hiding the lower lip is not the tongue (NO in Step S2250), the processor 210 returns the processing to Step S2230.

In Step S2260, the processor 210 controls the tongue of the avatar object 6 arranged in the virtual space 11 so as to be protruding from the mouth of the avatar object 6.

In Step S2270, the processor 210 outputs to the server 600 face tracking data (tongue tracking data) indicating that the tongue of the avatar object 6 is protruding from the mouth.

The server 600 transmits the received face tracking data to another computer 200 sharing the virtual space 11 with the recipient computer 200. As a result, the user using the another computer 200 can recognize the avatar object 900 having a protruding tongue.

In the above description, the HMD system 100 in the embodiment of this disclosure determines that the tongue of the user is protruding when the lower lip of the user is hidden, and hence the fact that the tongue of the user is protruding can be accurately detected even when the tongue of the user is only protruding a little. The HMD system 100 also determines whether or not the object hiding the tongue of the user is a tongue. Therefore, this system can suppress erroneous detection of the tongue of the user when the lower lip of the user is hidden by an object other than the tongue (e.g., user's hand).

[Processing for Determining Whether or Not Lower Lip is Hidden]

FIG. 23A and FIG. 23B are diagrams for illustrating a processing example of Step S2240 of FIG. 22. FIG. 23A is an illustration of a state in which the tongue of the user is slightly protruding from the mouth of the user. FIG. 23B is an illustration of a state in which the tongue of the user is greatly protruding from the mouth of the user.

The processor 210 detects outer contour points 2371 and inner contour points 2372 forming the lower lip by performing the series of processing steps described with reference to FIG. 15 to FIG. 17. As illustrated in FIG. 23A and FIG. 23B, the number of contour points (2371 and 2372) forming the lower lip detected when the tongue of the user is only slightly protruding is larger than the number of contour points forming the lower lip detected when the tongue of the user is greatly protruding. Through utilization of this characteristic, in one embodiment of this disclosure, the processor 210 can determine that at least a part of the lower lip is hidden when the number of contour points forming the lower lip becomes less than a threshold value. In one aspect, this threshold value maybe a set value determined in advance. In another aspect, the threshold value maybe determined in accordance with the length in the lateral direction of the lower lip. More specifically, the threshold value may be set such that when the length of the lower lip in the lateral direction is longer, the threshold value is larger.

In another aspect, the processor 210 may determine whether or not the lower lip is hidden based on an area of the detected lower lip. More specifically, as described with reference to FIG. 17, the processor 210 may detect the region forming the lower lip (region 1747 of FIG. 17).

As illustrated in FIG. 23A and FIG. 23B, the area of the region 2373 forming the lower lip is larger when the tongue of the user is greatly protruding than when the tongue of the user is slightly protruding. Through utilization of this characteristic, the processor 210 in another aspect may calculate the area of the lower lip, and determine that at least a part of the lower lip is hidden. when the calculated area of the lower lip becomes less than a threshold value.

In yet another aspect, the processor 210 may detect the lower lip of the user 5 from the image generated by the first camera 150, and then determine that the lower lip is hidden when the lower lip is no longer detectable. As described with reference to FIG. 15 to FIG. 17, the detection of the lower lip may be performed based on pattern matching between the image generated by the first camera 150 and the lower lip template 1435-2. Therefore, the fact that the lower lip can no longer be detected indicates that the similarity between the image generated by the first camera 150 and the lower lip template 1435-2 becomes less than the threshold value determined in advance.

[Determination of Whether or Not Object Hiding Lower Lip is Tongue]

FIG. 24 is a flowchart for illustrating a processing example of Step S2250 of FIG. 22.

In Step S2410, the processor 210 determines whether or not the similarity calculated based on pattern matching between the object hiding the lower lip and the tongue template 1435-3 stored in the memory module 530 is equal to or more than a threshold value.

When it is determined that the similarity is equal to or more than the threshold value (YES in Step S2410), the processor 210 determines that the object is the tongue (Step S2420). Meanwhile, when it is determined that the similarity is less than the threshold value (NO in Step S2410), the processor 210 determines that the object is not the tongue (Step S2430).

In another example, the processor 210 may determine whether or not the object is the tongue based on the shape of the object hiding the lower lip. For example, the processor 210 can determine that the object is the tongue when the shape of the object is a tapered shape (roughly triangular shape).

[Adjustment of Amount By Which Avatar Object is to Protrude Tongue]

In the embodiment described above, it is determined whether or not the tongue of the user is protruding. The HMD system described below detects an amount by which the tongue of the user is protruding from the mouth, and adjusts the amount by which the avatar object is to protrude its tongue in the virtual space.

FIG. 25 is an illustration of processing for detecting an amount by which the user is protruding his or her tongue. In FIG. 25, a tongue 2581 protrudes from the mouth of the user.

The processor 210 is capable of determining, based on the processing described with reference to FIG. 24, for example, that the object hiding the lower lip in the image generated by the first camera 150 is the tongue. When it is determined that the object hiding the lower lip is the tongue, the processor 210 calculates a distance L (number of pixels) from a tip 2582 of the tongue 2581 to an inner contour point 2583 forming the upper lip. The processor 210 controls the avatar object 6 so that when the calculated distance L is larger, the amount by which the avatar object 6 arranged in the virtual space protrudes its tongue is larger. In this case, the amount by which the avatar object 6 protrudes its tongue refers to the distance by which the tongue protrudes from the mouth of the avatar object 6.

In another aspect, the processor 210 may adjust the amount by which the avatar object 6 protrudes its tongue based on the distance from the tip 2582 of the tongue to an outer contour point 2584 forming the upper lip.

In the above-mentioned example, the processor 210 adjusts the amount by which the avatar object 6 protrudes its tongue based on the distance from the tip 2582 of the tongue to the upper lip, but the parameter to be used in order to adjust the amount by which the tongue protrudes is not limited to the above-mentioned example. The processor 210 may also adjust the amount by which the avatar object 6 protrudes its tongue based on the distance from the tip 2582 of the tongue to an organ determined in advance and forming the face of the user 5 (e.g., nose tip (nasal apex).

In still another aspect, when it is determined that the object hiding the lower lip is the tongue, the processor 210 may control the avatar object 6 such that the amount by which the avatar object 6 protrudes its tongue is larger when the area of the tongue (object) is larger.

FIG. 26 is a flowchart for illustrating processing in which the processor 210 controls the amount by which the avatar object 6 is to protrude its tongue. In the processing illustrated in FIG. 26, the processing steps denoted by the same reference numerals as those of FIG. 22 are the same as the processing steps of FIG. 22, and hence a description of those processing steps is not repeated here.

In Step S2610, the processor 210 calculates the distance between the reference organ (e.g., upper lip) forming the face of the user 5 and the tip of the tongue, and determines the amount by which the avatar object 6 is to protrude its tongue based on the calculated distance.

In Step S2620, the processor 210 causes the tongue of the avatar object 6 arranged in the virtual space 11 to protrude from the mouth of the avatar object 6 in accordance with the determined amount by which the tongue is to protrude.

In Step S2630, the processor 210 outputs to the server 600 data indicating the determined amount by which the tongue is to protrude. The server 600 transmits the received data to another computer 200 sharing the virtual space 11 with the recipient computer 200. As a result, the user using the another computer 200 may recognize the avatar object 6 having a tongue protruding by the adjusted amount.

With the processing described above, the processor 210 can adjust the amount by which the avatar object 6 arranged in the virtual space 11 is to protrude its tongue in accordance with the amount by which the user 5 is protruding his or her tongue from the mouth in the real space. Therefore, another user sharing the virtual space 11 with the user 5 can read a more specific facial expression of the user 5 via the avatar object 6. As a result, a user immersed in the virtual space 11 can achieve smoother communication.

[Configurations]

The technical features disclosed above may be summarized in the following manner.

(Configuration 1)

According to one embodiment of this disclosure, there is provided a method to be executed on a computer 200 to communicate via a virtual space 11. The method includes the steps of: defining (Step S2210) the virtual space 11; arranging (Step S2220) in the virtual space 11 an avatar object 900 of a user 5 communicating via the virtual space; repeatedly receiving (Step S2230) input of an image containing a mouth of the user; detecting (Step S2230) a lower lip of the user from the image; causing (Step S2260), when at least a part of the detected lower lip is hidden (YES in Step S2240), a tongue of an avatar object 6 to protrude from a mouth of the avatar object 6.

(Configuration 2)

In (Configuration 1), the step of causing a tongue of an avatar object 6 to protrude from a mouth of the avatar object 6 includes: determining (Step S2250), when it is determined that at least a part of the lower lip is hidden, whether or not an object hiding the lower lip is a tongue; and causing (Step S2260), when it is determined that the object is the tongue, the tongue of the avatar object 6 to protrude from the mouth of the avatar object 6.

(Configuration 3)

In (Configuration 2), the determining whether or not an object is a tongue includes determining (Step S2420) that the object is the tongue when a similarity between a tongue template 1435-3 stored in a memory module 530 and the object is equal to or more than a threshold value.

(Configuration 4)

In (Configuration 2) or (Configuration 3), the step of causing a tongue of an avatar object 6 to protrude from a mouth of the avatar object 6 includes increasing, when it is determined that the object is the tongue, an amount by which the avatar object 6 protrudes the tongue as an area of the tongue becomes larger.

(Configuration 5)

In (Configuration 2) or (Configuration 3), the step of causing a tongue of an avatar object 6 to protrude from a mouth of the avatar object 6 includes adjusting (Step S2610), when it is determined that the object is the tongue, an amount by which the avatar object 6 protrudes the tongue based on a distance between a reference organ forming a face of the user and a tip of the tongue.

(Configuration 6)

In (Configuration 5), the reference organ includes an upper lip of the user.

(Configuration 7)

In any one of (Configuration 1) to (Configuration 6), the step of causing a tongue of an avatar object 6 to protrude from a mouth of the avatar object 6 includes determining that at least a part of the lower lip is hidden when a similarity between a lower lip template 1435-2 stored in a memory module 530 and the image becomes less than a predetermined value.

(Configuration 8)

In anyone of (Configuration 1) to (Configuration 6), the step of detecting a lower lip includes detecting contour points of the lower lip. The step of causing a tongue of an avatar object 6 to protrude from a mouth of the avatar object 6 includes determining that at least a part of the lower lip is hidden a number of contour points of the lower lip becomes less than a threshold value.

(Configuration 9)

In anyone of (Configuration 1) to (Configuration 6), the step of causing a tongue of an avatar object 6 to protrude from a mouth of the avatar object 6 includes: calculating an area of the detected lower lip; and determining that at least a part of the lower lip is hidden when the calculated area of the lower lip is less than a threshold value.

(Configuration 10)

In any one of (Configuration 1) to (Configuration 9), the detecting a lower lip of the user includes performing pattern matching between the image and a lower lip template 1435-2 stored in a memory module 530.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the embodiment described above, the description is given by exemplifying the virtual space (VR space) in which the user is immersed using an HMD. However, in at least one embodiment, a see-through HMD is adopted as the HMD. In this case, in at least one embodiment, the user is provided with a virtual experience in an augmented reality (AR) space or a mixed reality (MR) space through output of a field-of-view image that is a combination of the real space recognized by the user via the see-through HMD and a part of an image forming the virtual space. In this case, in at least one embodiment, action is exerted on a target object in the virtual space based on motion of a hand of the user instead of the operation object. Specifically, in at least one embodiment, the processor identifies coordinate information on the position of the hand of the user in the real space, and defines the position of the target object in the virtual space in connection with the coordinate information in the real space. With this, the processor is able to grasp a positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

1. A method, comprising:
defining a virtual space, the virtual space including:
a first avatar object, which is associated with a first user, and includes a second mouth and a second tongue; and
a second avatar object, which is associated with a second user;
repeatedly receiving input of a face image containing a first mouth of the first user;
detecting that the face image contains a lower lip forming the first mouth;
detecting that at least a part of the detected lower lip is hidden;
changing, when at least a part of the lower lip is hidden, a state of the avatar object to a state in which the second tongue of the avatar object is protruding from the second mouth of the avatar object; and
displaying, in a field of view of the first user or the second user, the avatar object in a state in which the second tongue is protruding from the second mouth.

2. A method according to claim 1, further comprising:
determining, in response to a determination that at least a part of the lower lip is hidden, whether an object hiding the lower lip is the first tongue; and
changing, when it is determined that the object is the first tongue, the state of the avatar object to the state in which the second tongue is protruding from the second mouth.

3. A method according to claim 2, further comprising:
storing a tongue template relating to an image of a tongue of a person;
identifying a similarity between the tongue template and the object by comparing the tongue template and an image of the object; and
determining that the object is the first tongue when the similarity is equal to or more than a threshold value.

4. A method according to claim 2, further comprising:
identifying, when it is determined that the object is the first tongue, an area of the first tongue protruding from the first mouth; and
setting a larger area for the second tongue protruding from the second mouth as the area of the first tongue becomes larger.

5. A method according to claim 2, further comprising:
detecting a reference organ forming a face of the user;
identifying a distance between the reference organ and a tip of the first tongue; and
changing, when it is determined that the object is the first tongue, an area by which the second tongue is to protrude from the second mouth.

6. A method according to claim 5, wherein the reference organ includes an upper lip of the user.

7. A method according to claim 1, further comprising:
storing a lower tongue template relating to an image of a lower tongue of a person;
identifying a similarity between the lower lip template and the image by comparing the lower lip template and the image; and
determining, when the similarity is less than a predetermined value, that at least a part of the lower lip forming the first mouth is hidden.

8. A method according to claim 1, further comprising:
identifying a contour of the lower lip;
setting a plurality of points to be included on the contour;
identifying a number of the plurality of points; and
determining that at least a part of the lower lip is hidden when the number of the plurality of points has changed to being less than a threshold value.

9. A method according to claim 1, further comprising:
identifying an area of the lower lip; and
determining that at least a part of the lower lip is hidden when the area is less than a threshold value.

11. A method according to claim 1, further comprising:
transmitting, when at least a part of the lower lip is hidden, information indicating that at least a part of the lower lip is hidden to a computer associated with the second user from a computer associated with the first user;
receiving the information by the computer associated with the second user; and
displaying, in accordance with the information, in a field of view of the second user, the avatar object in a state in which the second tongue is protruding from the second mouth.

12. A method according to claim 1,
wherein the first user wears a head-mounted device including a camera configured to photograph a first portion covering a periphery of eyes of the first user and a second portion of a face of the user other than the first portion, and
wherein the method further comprises:
repeatedly acquiring, by the camera, an image containing a mouth of the user; and
repeatedly receiving input of the face image by using the repeatedly acquired image.
